(19) United States
(12) Patent Application Publication
(10) Pub. No.: US 2008/0140453 A1
(43) Pub. Date: Jun. 12, 2008

(54) SPEECH THERAPY CLINICAL PROGRESS TRACKING AND CASELOAD MANAGEMENT

(76) Inventors: Gretchen Bebb POPLINGER, Houston, TX (US); David Gregory RUNDLE, Tulsa, OK (US)

Correspondence Address: LOCKE LORD BISSELL & LIDDELL LLP;ATTN: IP DOCKETING, 600 TRAVIS, SUITE 3400, HOUSTON, TX, 77002-3095, US

(21) Appl. No.: 11/940,988

(22) Filed: Nov. 15, 2007

Related U.S. Application Data
(60) Provisional application No. 60/866,051, filed on Nov. 15, 2006.

(51) Int. Cl. G06F 19/00

(52) U.S. Cl. 705/3; 705/1

(57) ABSTRACT

System and method are disclosed for speech therapy clinical progress tracking and caseload management. In some embodiments, computerized data collection and organization are used in order to meet federally mandated guidelines, efficiently document and follow client progress, and track various administrative actions associated with client care. In some embodiments, evaluation, treatment and discharge stages of treatment are organized and quantified. A continuous care plan improvement approach is used that focuses on written justification of functional progress, leading incrementally to a successful care plan outcome. In some embodiments, documents contain the same data sections, including client data, speech services data, assessment data, treatment plan data, and recommendations data. This arrangement provides clinicians with the confidence of knowing their documentation meets all industry standards, and gives administrators the tools to bill and manage back office client services.

### CROSS-REFERENCE TO RELATED APPLICATIONS

This application for patent claims the benefit of priority to, and incorporates herein by reference in its entirety, U.S. Provisional Application Ser. No. 60/866,051, entitled “Speech Therapy Documentation and Caseload Management System and Method,” filed Nov. 15, 2006.

### COPYRIGHT NOTICE

This application for patent contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### TECHNICAL FIELD

This application for patent discloses subject matter that relates generally to provision of speech therapy services and, more specifically, to systems and methods for tracking clinical progress of clients who received such speech therapy services.

### BACKGROUND

Speech-language pathologists, or sometimes speech therapists, are highly-trained healthcare professionals who assess, diagnose, and treat speech, language, cognitive-communication, and other speech-related disorders. The speech therapists also counsel individuals and their families concerning communication disorders and how to cope with the stress and misunderstanding that often accompany them. They additionally work with family members to recognize and change behavior patterns that impede communication and treatment (“Tx”) and show them communication-enhancing techniques to use at home.

An important aspect of a speech therapist's responsibility is tracking the progress of the clients to whom they provide speech therapy services. The speech therapists typically record the initial evaluation, treatment provided, progress made, and the eventual discharge (“Dc”) of the client. These records help pinpoint problems, track client progress, and justify the cost of treatment when applying for reimbursement from insurance companies, Medicare, and other funding sources. The records also help to facilitate management, accounting, and administration of caseloads for speech therapy service providers.

Currently, tracking of a speech therapy client's clinical progress is a largely manual process insofar as most speech therapists record their clients' progress using handwritten notations on pre-printed forms or charts. Some speech therapy service providers have advanced beyond manual tracking by providing simple spreadsheets and similar programs for their clinicians to use. However, these ad-hoc solutions provide only a minimal level of automation and do not allow the clinicians, for example, to compare the progress of clients over time. Moreover, the ad-hoc solutions tend to produce reports with varying and disparate formats between service providers, and also fail to comply with insurance company requirements for service codes and the type of data reported.

Indeed, recent ASHA (American Speech-Language-Hearing Association) survey information lists paperwork requirements and reimbursement issues as two of the primary difficulties facing speech pathologists. In addition, insurance company demands for service justification have grown as therapy funding sources enforce increasingly stricter policy limitations on their members. These limitations create a greater need for medical specificity from speech therapy service providers and the need to show progress through the course of treatment. As a result, it has become essential for speech therapy service providers to be able to portray and document functional gains in order to successfully obtain funding source reimbursement. This is particularly the case as many insurance companies and funding sources begin to shift toward a pay-for-performance reimbursement model.

Accordingly, what is needed is a way to track and manage the clinical progress of speech therapy clients that addresses the issues and shortcomings described above as well as other issues.

### SUMMARY

The disclosed embodiments provide a system and method for speech therapy clinical progress tracking and caseload management. In some embodiments, the method and system use computerized data collection and organization that are designed to meet federally mandated guidelines, efficiently document and follow client progress, and track various administrative actions associated with client care. In some embodiments, the method and system organize, quantify, and track clinical data through the evaluation, treatment and discharge stages of treatment. The method and system use a continuous care plan improvement approach that focuses on written justification of functional progress, leading incrementally to a successful care plan outcome. In some embodiments, documents generated by the method and system contain the same data sections in order to meet documentation standards. These data sections may include, for example, client data, speech services data, assessment data, treatment plan data, and recommendations data. Such an arrangement gives clinicians the confidence of knowing their documentation meets industry standards, and gives administrators the tools to bill and manage back office client services.

In general, in one aspect, the disclosed embodiments are directed to a computerized system of managing therapy services provided to clients. The system comprises at least one subsystem configured to store assessment information, treatment plan information, and recommendation information for a client. The system also comprises at least one subsystem configured to record progress notes of treatment sessions for the client, each progress note including treatment information pertaining to one treatment session. The system further comprises at least one subsystem configured to track an amount of clinical progress for the client over multiple treatment sessions, wherein the amount of clinical progress for the client is automatically derived based at least on the progress notes for the client.

In general, in another aspect, the disclosed embodiments are directed to a computerized method of managing therapy services provided to clients. The method comprises storing assessment information, treatment plan information, and recommendation information for a client. The method also comprises recording progress notes of treatment sessions for the client, each progress note including treatment information pertaining to one treatment session. The method further comprises tracking an amount of clinical progress for the client over multiple treatment sessions, wherein the amount of clinical progress for the client is automatically derived based at least on the progress notes for the client.

In general, in yet another aspect, the disclosed embodiments are directed to a computer-readable medium encoded with computer-readable instructions for managing therapy services provided to clients. The computer-readable instructions comprising instructions for causing a computer to store assessment information, treatment plan information, and recommendation information for a client. The computer-readable instructions also comprises instructions for causing a computer to record progress notes of treatment sessions for the client, each progress note including treatment information pertaining to one treatment session. The computer-readable instructions further comprises instructions for causing a computer to track an amount of clinical progress for the client over multiple treatment sessions, wherein the amount of clinical progress for the client is automatically derived based at least on the progress notes for the client.

### BRIEF DESCRIPTION OF THE DRAWINGS

The foregoing and other advantages will become apparent from the following detailed description and upon reference to the drawings, wherein:

The foregoing and other advantages will become apparent from the following detailed description and upon reference to the drawings, wherein:

FIG. 1 illustrates an exemplary infrastructure for speech therapy clinical progress tracking and caseload management according to the disclosed embodiments;

FIG. 2 illustrates an exemplary system for speech therapy clinical progress tracking and caseload management according to the disclosed embodiments;

FIG. 3 illustrates an exemplary client data section for an evaluation report according to the disclosed embodiments;

FIG. 4 illustrates an exemplary list of insurance codes for an evaluation report according to the disclosed embodiments;

FIG. 5 illustrates another exemplary list of insurance codes for an evaluation report according to the disclosed embodiments;

FIG. 6 illustrates an exemplary speech services section for an evaluation report according to the disclosed embodiments;

FIG. 7 illustrates an exemplary client assessment section for an evaluation report according to the disclosed embodiments;

FIG. 8 illustrates an exemplary list of client functions for an evaluation report according to the disclosed embodiments;

FIG. 9 illustrates an exemplary interface for editing comments on client functions for an evaluation report according to the disclosed embodiments;

FIG. 10 illustrates an exemplary treatment plan section for an evaluation report according to the disclosed embodiments;

FIG. 11 illustrates an exemplary recommendations section for an evaluation report according to the disclosed embodiments;

FIG. 12 illustrates an exemplary calendar interface for creating progress notes according to the disclosed embodiments;

FIG. 13 illustrates an exemplary progress note according to the disclosed embodiments;

FIG. 14 illustrates an exemplary client data section for a progress report according to the disclosed embodiments;

FIG. 15 illustrates an exemplary speech services section for a progress report according to the disclosed embodiments;

FIG. 16 illustrates an exemplary client assessment section for a progress report according to the disclosed embodiments;

FIG. 17 illustrates an exemplary treatment section for a progress report according to the disclosed embodiments;

FIG. 18 illustrates an exemplary recommendations section for a progress report according to the disclosed embodiments;

FIG. 19 illustrates an exemplary client data section for a discharge report according to the disclosed embodiments;

FIG. 20 illustrates an exemplary speech services section for a discharge report according to the disclosed embodiments;

FIG. 21 illustrates an exemplary client assessment section for a discharge report according to the disclosed embodiments;

FIG. 22 illustrates an exemplary treatment section for a discharge report according to the disclosed embodiments;

FIG. 23 illustrates an exemplary recommendations section for a discharge report according to the disclosed embodiments;

FIG. 24 illustrates an exemplary tracking summary according to the disclosed embodiments;

FIG. 25 illustrates an exemplary billing summary according to the disclosed embodiments; and

FIG. 26 illustrates an exemplary method for speech therapy clinical progress tracking and caseload management according to the disclosed embodiments.

### DETAILED DESCRIPTION

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial embodiment of the inventions are described or shown for the sake of clarity and understanding.

Persons of skill in this art will also appreciate that the development of an actual commercial embodiment incorporating aspects of the inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It should be understood that the embodiments disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims.

Particular embodiments are now described with reference to block diagrams and/or operational illustrations of methods. It should be understood that each block of the block diagrams and/or operational illustrations, and combinations of blocks in the block diagrams and/or operational illustrations, may be implemented by analog and/or digital hardware, and/or computer program instructions. Computer programs instructions for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system.

The executed instructions may also create structures and functions for implementing the actions specified in the mentioned block diagrams and/or operational illustrations. In some alternate implementations, the functions, actions, and/or structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

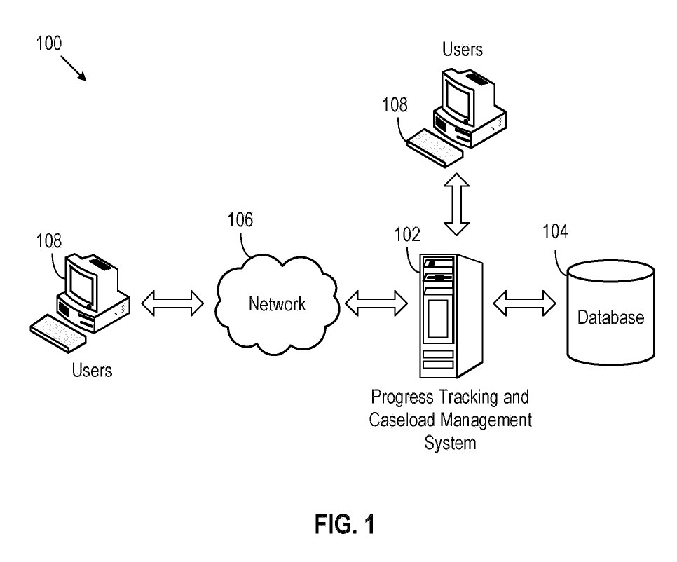

Referring now to FIG. 1, an exemplary infrastructure 100 is shown that is capable of being used for speech therapy clinical progress tracking and caseload management according to the disclosed embodiments. The exemplary infrastructure 100 includes a progress tracking and caseload management system 102, and method therefor, for documenting and tracking the clinical progress of speech therapy clients. A database 104 may be connected to the system 102 for storing various data associated with each client, speech therapy service provider, and the like. The progress tracking and caseload management system 102 may in turn be connected to a global network 106, such as the Internet, for allowing one or more users to remotely access the system 102. Users may then access the progress tracking and caseload management system 102 (and method therefor) via the World Wide Web, for example, using ASP.NET technology available from Microsoft Corp. of Redmond, Wash. Other suitable global access technology may also be used to implement the disclosed embodiments without departing from the scope of the invention.

In some embodiments, users may be different speech therapy service providers who have licensed or otherwise obtained authorization to use the progress tracking and caseload management system 102. Thus, the progress tracking and caseload management system 102 (and method therefor) may serve in these embodiments as a centralized repository of data that the speech therapy service providers may access over the network 106. An advantage of this arrangement is that little setup is required insofar as a computer with a Web browser and network access capability may be all that is needed by users to access and use the progress tracking and caseload management system 102 (and method therefor). To prevent unauthorized access, the system 102 may be set up on a secured network, such as a virtual private network (VPN) and the like. Speech pathologists and speech therapy service providers may then access the VPN from virtually any location to view, modify, and update their reports and data as needed.

In other embodiments, the progress tracking and caseload management system 102 (and method therefor) may be deployed for local access, for example, on an individual office basis. Thus, each speech therapy service provider may have its own installation of the progress tracking and caseload management system 102 (and method therefor) for its own offices. In such an arrangement, local users may access the progress tracking and caseload management system 102 either directly or over a local area network (not expressly shown) instead of the global network 106. It is also possible, of course, to deploy a combination of local and remote access to the progress tracking and caseload management system 102 (and method therefor) without departing from the scope of the disclosed embodiments.

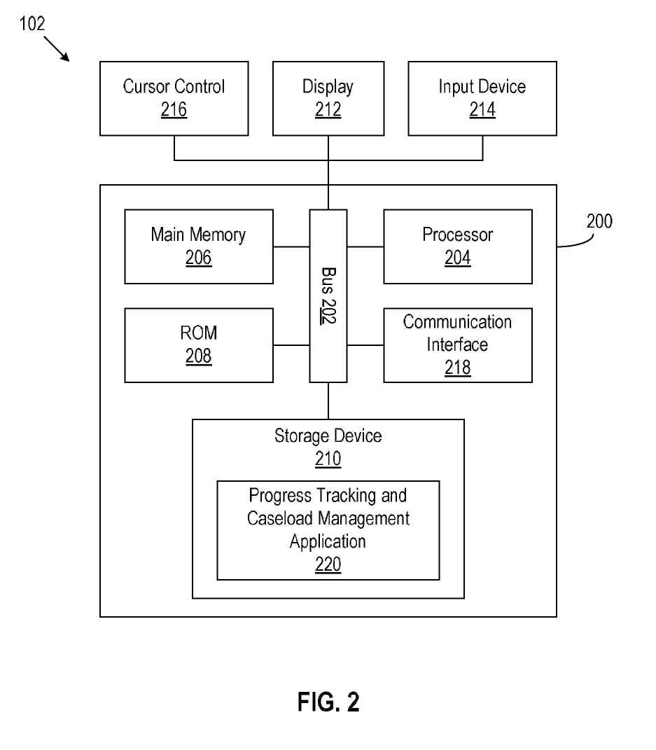

FIG. 2 illustrates an example of the progress tracking and caseload management system 102 according to the disclosed embodiments. As can be seen, in some embodiments, the progress tracking and caseload management system 102 may be composed of a typical computer system 200. Any suitable computer system 200 known to those having ordinary skill in the art may be used as the progress tracking and caseload management system 102, including a personal computer, server, workstation, mainframe, and the like. Furthermore, although a single computer system is shown in FIG. 2, those having ordinary skill in the art will understand that the progress tracking and caseload management system 102 may include multiple computer systems working in conjunction with one another.

The computer system 200 typically includes a bus 202 or other communication mechanism for communicating information and a processor 204 coupled with the bus 202 for processing information. The computer system 200 may also include a main memory 206, such as a random access memory (RAM) or other dynamic storage device, coupled to the bus 202 for storing computer-readable instructions to be executed by the processor 204. The main memory 206 may also be used for storing temporary variables or other intermediate information during execution of the instructions to be executed by the processor 204. The computer system 200 may further include a read-only memory (ROM) 208 or other static storage device coupled to the bus 202 for storing static information and instructions for the processor 204. A computer-readable storage device 210, such as a magnetic, optical, or solid state device, may be coupled to the bus 202 for storing information and instructions for the processor 204.

The computer system 200 may be coupled via the bus 202 to a display 212, such as a cathode ray tube (CRT) or liquid crystal display (LCD), for displaying information to a customer. An input device 214, including, for example, alphanumeric and other keys, may be coupled to the bus 202 for communicating information and command selections to the processor 204. Another type of customer input device may be a cursor control 216, such as a mouse, a trackball, or cursor direction keys for communicating direction information and command selections to the processor 204, and for controlling cursor movement on the display 212. The cursor control 216 typically has two degrees of freedom in two axes, a first axis (e.g., X axis) and a second axis (e.g., Y axis), that allow the device to specify positions in a plane.

The term “computer-readable instructions” as used above refers to any instructions that may be performed by the processor 204 and/or other components. Similarly, the term “computer-readable medium” refers to any storage medium that may be used to store the computer-readable instructions. Such a medium may take many forms, including, but not limited to, non volatile media, volatile media, and transmission media. Non volatile media may include, for example, optical or magnetic disks, such as the storage device 210. Volatile media may include dynamic memory, such as main memory 206. Transmission media may include coaxial cables, copper wire and fiber optics, including wires of the bus 202. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Various forms of the computer-readable media may be involved in carrying one or more sequences of one or more instructions to the processor 204 for execution. For example, the instructions may initially be borne on a magnetic disk of a remote computer. The remote computer can load the instructions into its dynamic memory and send the instructions over a telephone line using a modem. A modem local to the computer system 200 can receive the data on the telephone line and use an infrared transmitter to convert the data to an infrared signal. An infrared detector coupled to the bus 202 can receive the data carried in the infrared signal and place the data on the bus 202. The bus 202 carries the data to the main memory 206, from which the processor 204 retrieves and executes the instructions. The instructions received by the main memory 206 may optionally be stored on the storage device 210 either before or after execution by the processor 204.

The computer system 200 may also include a communication interface 218 coupled to the bus 202. The communication interface 218 typically provides a two way data communication coupling between the computer system 200 and the network 110. For example, the communication interface 218 may be an integrated services digital network (ISDN) card or a modem used to provide a data communication connection to a corresponding type of telephone line. As another example, the communication interface 218 may be a local area network (LAN) card used to provide a data communication connection to a compatible LAN. Wireless links may also be implemented. Regardless of the specific implementation, the main function of the communication interface 218 is to send and receive electrical, electromagnetic, optical, or other signals that carry digital data streams representing various types of information.

In accordance with the disclosed embodiments, a progress tracking and caseload management application 220, or more precisely, the computer-readable instructions therefor, may reside on the storage device 210. The progress tracking and caseload management application 220 may then be executed to allow users to track and quantify the clinical progress of speech therapy clients and to attend to the various administrative aspects associated therewith. Thus, for example, users may use the progress tracking and caseload management application 220 to associate a monetary value to the treatment and progress of the speech therapy clients for insurance reimbursement purposes. The progress tracking and caseload management application 220 may also allow the user to evaluate the progress of the speech therapy clients over time in order to derive an accurate estimate of the number of services, the length of time for each service, the cost of providing the services, and the like. The progress tracking and caseload management application 220 then allows users to generate progress reports that contain all information and payment codes needed by insurance companies and other funding sources in order to process reimbursement payments.

It should be noted that, although the progress tracking and caseload management application 220 is described with respect to speech therapy services, those having ordinary skill in the art will recognize that the principles and concepts disclosed herein are fully applicable to other types of therapy. Examples of other types of therapy services that may benefit from use of the disclosed embodiments may include occupational therapy services, physical therapy services, psycho therapy services, chemotherapy services, and the like.

In some embodiments, the progress tracking and caseload management application 220 may include, or may otherwise implement, a continuous care plan improvement approach. As alluded to earlier, speech-language pathologists typically complete evaluation reports, progress reports, and discharge summaries to satisfy accepted documentation requirements. Clinical data are summarized at segmented intervals to reflect the current course and results of therapy. Attempts to join these segmented reports into a cohesive unit involve painstaking reiteration of facts, observant documentation of current clinical progress, and articulate portrayal of changing goals and procedures. And the resulting reports are inherently cumbersome and often disjointed.

The continuous care plan improvement approach addresses the above shortcoming by promoting organized, comprehensive, and cohesive reporting, and simplifying documentation focus. Thus, in some embodiments, the continuous care plan improvement approach records and directs treatment activities that are focused on client goal orientation and mastery. To this end, the continuous care plan improvement approach may provide evaluation reports, progress reports, discharge summaries, daily progress notes, and the like. The term “care plan” refers to a total-picture approach to clinical documentation that includes all the information documented during an individual's course of speech-language pathology treatment. The “continuous improvement” concept promotes an inherent focus on client progress and goal mastery during the course of treatment.

In some embodiments, separate documents may be joined into a single continuous care plan improvement approach unit using features of the progress tracking and caseload management application 220. These features include (1) a standard overall structure for each report, and (2) a clinical progress tracker. With respect to the first feature, the standard overall structure of each report may be a comprehensive outline format that may be shared by all report documents. The outline may include five standard data sections or categories, with each category listing information specific to certain required documentation standards. Such a standard overall structure allows information in the various report documents to be presented in the same or a similar format.

With respect to the clinical progress tracker, this component provides a graphical interface for recording and tracking clinical progress from the onset to the termination of therapy. The clinical progress tracker enables therapists to design focused, goal-oriented treatment strategies and to adjust those strategies according to documented clinical progress. The clinical progress tracker and the continuous care plan improvement approach together help minimize documentation time and maximize clinical management focus. This gives therapists a targeted, comprehensive approach to the reporting of data, while meeting current documentation standards. It also provides a structure for efficient, goal-oriented therapy, and helps redirect the emphasis of daily activities toward face-to-face therapeutic interactions affecting client progress.

In some embodiments, the progress tracking and caseload management application 220 also includes an administrative caseload management component that addresses various administrative needs associated with client care management. The administrative caseload management component may address, for example, client intake information, scheduling, billing submissions, client deliverables and management reports. A daily billing report, which may be used in tandem with the clinical progress tracker, provides a portal for transmitting all clinical data necessary to manage administrative accounting activities and insurance company transactions.

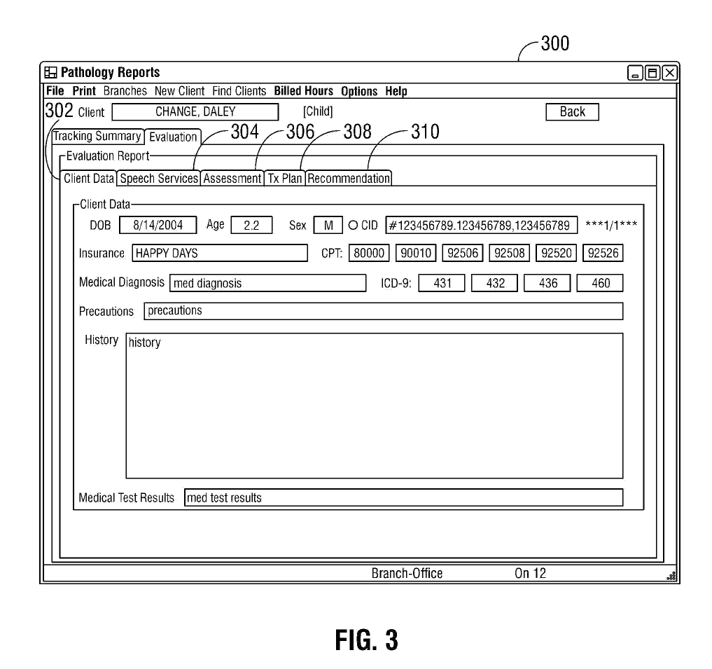

FIGS. 3-26 illustrate an exemplary implementation of the progress tracking and caseload management application 220 via series of graphical user interfaces for displaying information to users and receiving input from users. The graphical user interfaces may be, for example, Web-based interfaces, but any graphical user interface known to those having ordinary skill in the art may be used. Moreover, although a particular design and layout are shown, those having ordinary skill in the art will recognize that many designs and layouts may be used for the graphical user interface without departing from the scope of the disclosed embodiments.

Referring now to FIG. 3, in accordance with the disclosed embodiments, an evaluation report 300 may be provided for conducting an evaluation of the client. The evaluation report 300 may be designed to provide an orderly, comprehensive summary of the results of a speech pathology evaluation. A new client option (not expressly shown) from the File menu allows users to select the type of evaluation report 300 they want to create. For example, users may select from adult, child, infant, dysphagia and other reports (not expressly shown) to create the evaluation report 300. The exemplary evaluation report 300 shown in FIG. 3 is for a child.

As can be seen in FIG. 3, the evaluation report 300 has five data sections, including a client data section 302, speech services data section 304, assessment data section 306, treatment plan data section 308 and recommendations section 310. As mentioned above, other reports may share the same or a similar outline format in order to provide a consistent look and feel across the various reports. To access each data section, users may click on the appropriate tab to activate that data section. Following is a section-by-section explanation of the data sections of the evaluation report 300.

In the client data section 302, users may enter the client's last name and first name, the client's date of birth by month, day, year (the client's age may then be automatically calculated). Users may also enter the client's gender (“M” or “F”), Social Security Number (SS#) or Client Identification (CID), and the client's insurance company name or NA (Not Applicable) if not applicable. A medical diagnoses area allows users to list the client's primary functional medical diagnosis that resulted in the need for therapeutic intervention and the secondary diagnoses as needed next to the primary diagnosis. Examples may include Down syndrome, right/left CVA (cerebrovascular), dysarthria, central auditory processing, speech delay, and the like.

In some embodiments, the client data section 302 may also include fields for allowing users to enter insurance codes in order to request insurance reimbursement. Insurance reimbursement systems generally require codes that accurately reflect the client's diagnosis and the clinical procedures performed. Healthcare providers may account for the procedures performed and the relationship of those procedures to the medical diagnosis. Coding systems provide a means of information transfer between the healthcare professional and the financially responsible party. Codes provide insurance companies with knowledge about a client's diagnosis and the treatment procedures. The most commonly used coding systems are the ICD9 (diagnosis), CPT (treatment procedures) and HCPCS systems.

CPT (Current Procedural Terminology) codes were developed and published by the American Medical Association. The CPT codes are 5 digit codes with available 2 digit modifiers forming the basis for specifying the type of treatment given. For example, 92506 marks speech and language evaluations for payments and 92507 denotes speech and language treatment. More than one code may be used per session, a practice referred to as “bundling.” For example, evaluation charges may include 92506 (speech and language evaluation), 99202 (case history), and 92507 (trial therapy performed as a single unit and documented at the time of evaluation). However, multiple procedures billed on a given day may be subject to scrutiny. A list of current coding edits, or allowed bundling practices, is available on the American Speech Language Hearing Association website at www.asha.org.

ICD9 (International Classification of Disease) codes were developed by the World Health Organization (WHO) to identify diseases and conditions requiring the need for medical services. ICD coding for a hospital client might include a primary medical diagnosis (e.g., CVA, 437.1), related conditions (e.g., hypertension, 401.0), and resulting conditions (e.g., dysphagia, 438.82, aphasia, late effect of cerebrovascular disease 438.11). Note that Medicare requires medical diagnoses to carry the highest level of specificity. Thus, for speech pathologists who treat swallowing disorders, this means “dysphagia” may be the primary diagnosis with CVA as the supportive medical condition.

HCPCS codes were added by the Health Care Finance Administration (HCFA) in March 1990 as an additive to the CPT code system. HCPCS Level II codes describe durable medical equipment, such as alternative communication devices or artificial larynges.

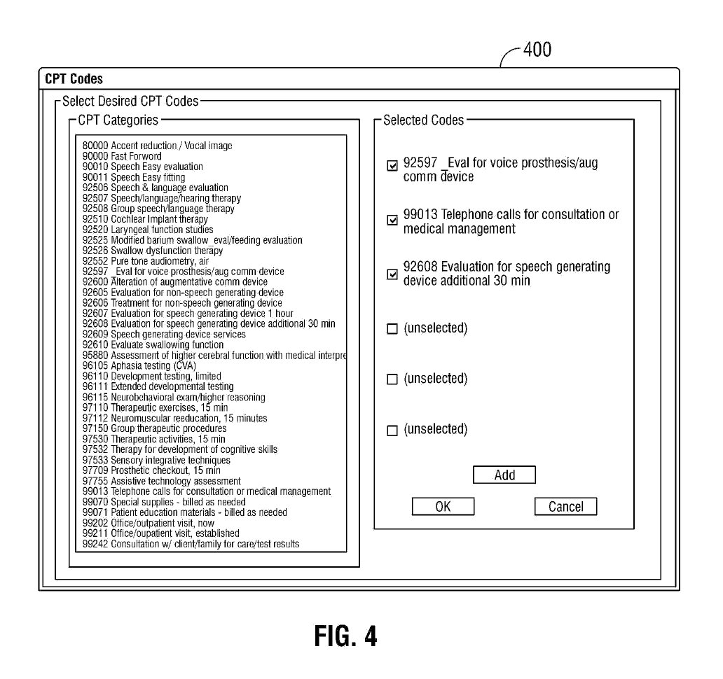

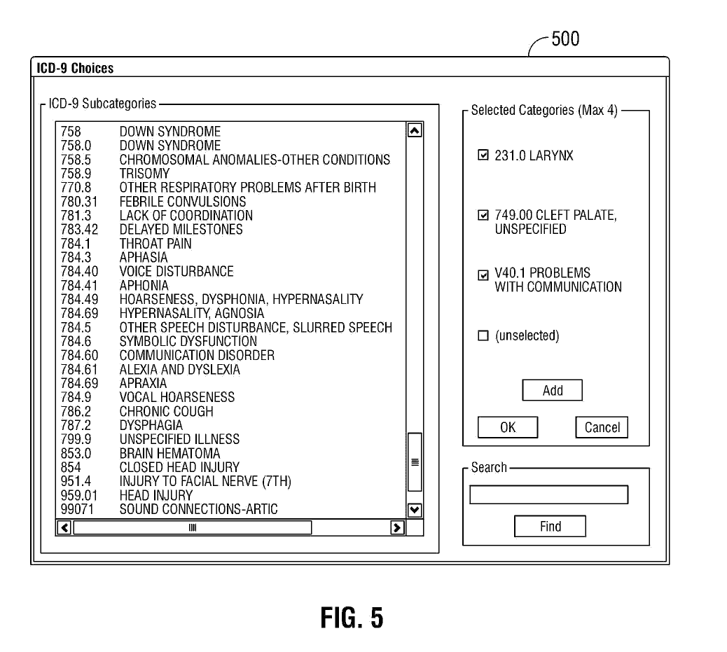

In accordance with the disclosed embodiments, the client data section 302 may provide users with a list of CPT and ICD9 codes commonly used in speech therapy from which they may select. Users may access these codes, for example, by clicking on the appropriate box next to the CPT or ICD9 code markers. Doing so brings up a listing of available codes, as shown at 400 and 500 in FIGS. 4 and 5, respectively. Users may then select one or more codes from the listings 400 and 500 (left-hand side) by clicking on the desired code and selecting an “Add” button to add it to the list of selected codes 402 and 502 (the right-hand side), respectively. To remove a code, users may click on the code or check the box next to the code. In the embodiment shown, up to six codes may be added per report, and codes may be changed as needed until the report is finalized.

In some embodiments, the client data section 302 may also include a client history field for allowing users to give a brief, pertinent medical and social history for the client. The medical history may include, for example, a statement indicating the client's functional level prior to onset of the condition, a comparative statement describing how the client's functional ability changed following exacerbation of a previous condition, or a description of the impact on the client's life, and the like.

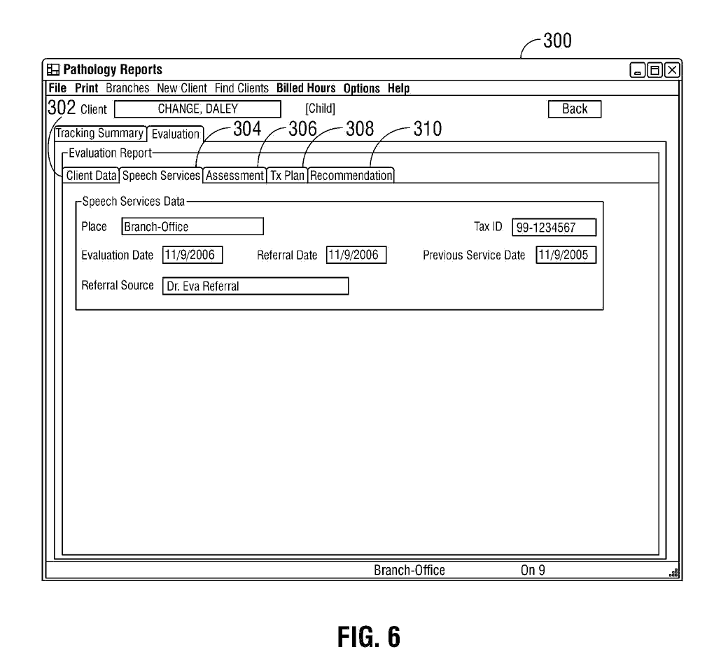

Referring now to FIG. 6, the speech services data section 304 of the evaluation report 300 allows users to enter information concerning the speech therapy service provider. For example, users may enter the place of therapy service delivery. Alternatively, the place of therapy service delivery may populate automatically based on the facility location specified by the users under the Branches auction on the file menu. Other information that may be entered by users or populated automatically include, for example, the provider Tax ID, the date the report is created, and the date the evaluation was initiated (if the report is created on a date different from the evaluation date). This date typically identifies the beginning of the continuous care plan improvement approach and designates the first billable visit. Still other information that may be provided by users may include referral date, previous service date, referral source, and the like.

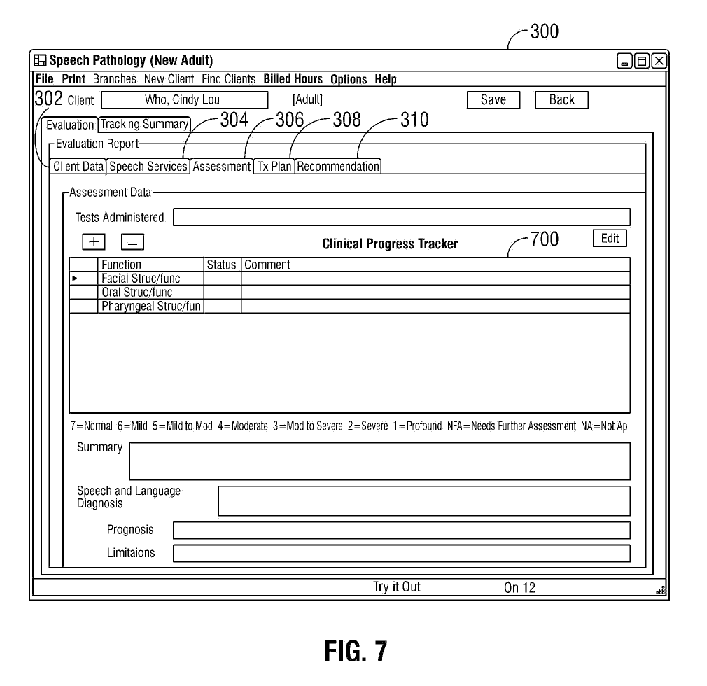

FIG. 7 illustrates the assessment data section 306 of the evaluation report 300 according to the disclosed embodiments. This section allow users to enter information concerning the assessment of the client. Thus, for example, the section may include a field or an area for entering the tests that were administered, such as the formal and/or informal tests given to the client during the evaluation. The tests may be entered freehand in some embodiments, or they may be selected from a predefined list of tests by clicking on the desired tests. Examples of tests may include oral peripheral, hearing screen, Goldman-Fristoe test of articulation, functional voice assessment, computer voice analysis, trial therapy, and the like.

In addition, a clinical progress tracker 700 may be provided in the assessment data section 306 according to the disclosed embodiments. The clinical progress tracker 700 to outlines pertinent evaluation findings for the client, thus providing an individualized picture of the client's communication strengths and weaknesses. In some embodiments, there may be three sections in the clinical progress tracker 700, including function, status and comment sections.

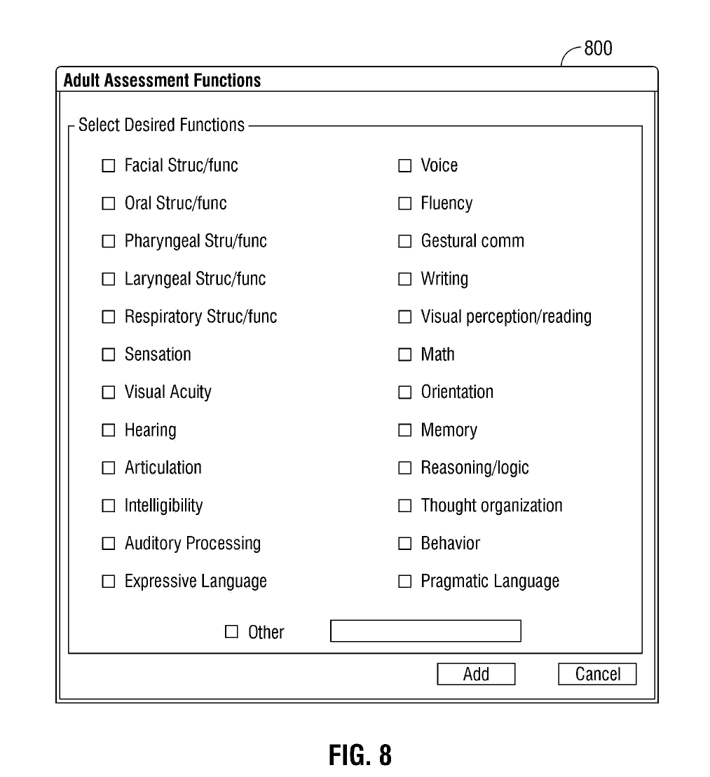

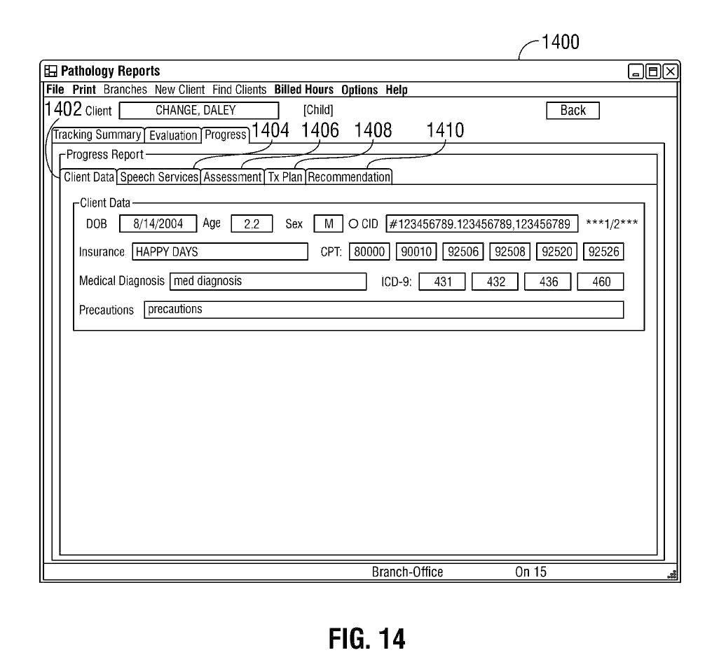

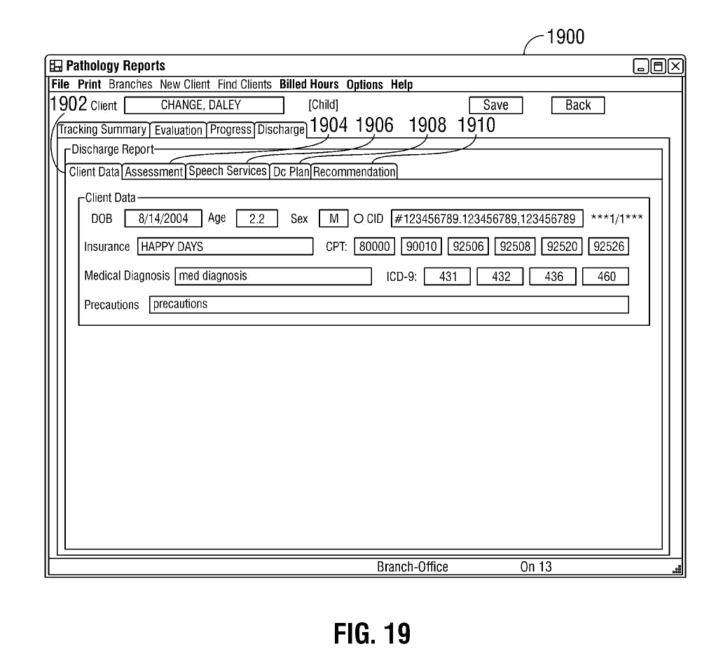

The function section of the clinical progress tracker 700 allows users to select categories of functional skills assessed during the evaluation and generate a profile of the client's communication need areas. In some embodiments, clicking on a “+” sign allows users to access the functional communication categories, an exemplary listing for which is shown at 800 in FIG. 8. These categories may vary by evaluation report type because functional needs may differ among adult, child, infant and dysphagia populations. Users may create an individualized client profile by selecting the categories assessed during the evaluation. Users may also add any unlisted categories by typing in the desired categorical designation under “other,” and may select categories for the clinical progress tracker 700 by clicking a designated button. After selecting the description categories, the function section in the clinical progress tracker 700 may list those selections. Function categories may be added (+) or deleted (−) freely until the report is finalized. The selected categories create a functional client picture and provide a platform for generating progress and discharge reports, discussed later herein with respect to FIGS. 14 and 19, respectively.

The status section of the clinical progress tracker 700 may be used to indicate the degree of severity associated with the corresponding function category. In some embodiments, available degrees of severity ratings may be displayed in a legend below the clinical progress tracker 700, with a rating of 7 being normal and 1 being profound, for example. Such severity ratings allow family members, doctors and insurance reviewers to understand the degree of the disorder. These severity ratings may be used with notations, such as “Was,” “Different,” “Now,” and the like, in subsequent progress reports, which may be automatically populated, in order to allow users to visualize clinical progress numerically over time.

It is important to correctly specify a client's functional status. This may be done by recording, for example, standardized test data that provide a severity rating scale with the test measure, standardized test data that provide percentage-based scores without severity specifications, and/or professional clinical judgments. Examples of standardized tests include the Ross Information Processing Assessment, Stuttering Prediction Instrument, and the like. Many standardized tests provide severity scales to help insure inter-rater reliability and facilitate interdisciplinary communication. These tests should be reported with standardized terminology and categorical classifications coinciding with test results.

Percentage-based scores without severity specifications leave the determination of what is normal or disordered to the diagnostician. It is important therefore to label severity ratings accurately so that subsequent progress and discharge reports show incremental progress through test/retest reliability and through recorded documentation of objective mastery.

Tables 1 and 2 below illustrate exemplary 7-point severity ratings for adults and 5-point severity ratings for children and infants, respectively. These severity rating provide non-standard, gradual increment scales based on the inventor's experience and preference. The 7-point scale reflects measures regularly used in many rehabilitation facilities while the 5-point scale should be used for children and infants.

TABLE 1
7-point scale
Use this scale with adult and dysphagia documents.

| | | |
|---|---|---|
| 95-100% | 7 = | Normal |
| 85-94% | 6 = | Mild |
| 75-84% | 5 = | Mild to Moderate |
| 60-74% | 4 = | Moderate |
| 45-59% | 3 = | Moderate to Severe |
| 25-44% | 2 = | Severe |
| 0-24% | 1 = | Profound |

TABLE 2
5-point scale
Use this scale with infant and child documents. See the 5-Point
Percentage Equivalency Chart for infant percentage computations.

| | | |
|---|---|---|
| 90-100%% | 5 = | Normal |
| 75-89% | 4 = | Mild |
| 55-74% | 3 = | Moderate |
| 30-54% | 2 = | Severe |
| 0-29% | 1 = | Profound |

Table 3 below illustrates a 5-point infant scale that represents a percentage of the days a child is old against their chronological age. More specifically, if children function at 90-100% of the days they are old, then they function at a normal level. Conversely, if they function at 0-29% of the days they are old, then they have a profound communication disorder. This scale may be used to make specific calculations of an infant's functional abilities in relationship to chronological age.

TABLE 3
Five-point percentage equivalency chart (Infant document)

| | | Chronological Age/Months | | | | | | | | | | | | | | | | | | |
|---|---|---|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 | 17 | 18 | 19 |
| Skill | 1 | 5 | 4 | 3 | 2 | 1 | 1 | 1 | 1 | 1 | 1 | 1 | 1 | 1 | 1 | 1 | 1 | 1 | 1 | 1 |
| Level/ | 2 | | 5 | 4 | 3 | 2 | 2 | 2 | 1 | 1 | 1 | 1 | 1 | 1 | 1 | 1 | 1 | 1 | 1 | 1 |
| Months | 3 | | | 5 | 4 | 3 | 2 | 2 | 2 | 2 | 2 | 1 | 1 | 1 | 1 | 1 | 1 | 1 | 1 | 1 |
| | 4 | | | | 5 | 4 | 3 | 3 | 2 | 2 | 2 | 2 | 2 | 2 | 1 | 1 | 1 | 1 | 1 | 1 |
| | 5 | | | | | 5 | 4 | 3 | 3 | 3 | 2 | 2 | 2 | 2 | 2 | 2 | 2 | 1 | 1 | 1 |
| | 6 | | | | | | 5 | 4 | 3 | 3 | 3 | 2 | 2 | 2 | 2 | 2 | 2 | 2 | 2 | 2 |
| | 7 | | | | | | | 5 | 4 | 4 | 3 | 3 | 3 | 2 | 2 | 2 | 2 | 2 | 2 | 2 |
| | 8 | | | | | | | | 5 | 4 | 4 | 3 | 3 | 3 | 2 | 2 | 2 | 2 | 2 | 2 |
| | 9 | | | | | | | | | 5 | 4 | 4 | 3 | 3 | 3 | 3 | 3 | 2 | 2 | 2 |
| | 10 | | | | | | | | | | 5 | 5 | 4 | 4 | 3 | 3 | 3 | 3 | 2 | 2 |
| | 11 | | | | | | | | | | | 5 | 5 | 4 | 4 | 3 | 3 | 3 | 3 | 3 |
| | 12 | | | | | | | | | | | | 5 | 5 | 4 | 4 | 3 | 3 | 3 | 3 |
| | 13 | | | | | | | | | | | | | 5 | 5 | 4 | 4 | 3 | 3 | 3 |
| | 14 | | | | | | | | | | | | | | 5 | 5 | 4 | 4 | 3 | 3 |
| | 15 | | | | | | | | | | | | | | | 5 | 5 | 4 | 4 | 4 |
| | 16 | | | | | | | | | | | | | | | | 5 | 5 | 4 | 4 |
| | 17 | | | | | | | | | | | | | | | | | 5 | 5 | 4 |
| | 18 | | | | | | | | | | | | | | | | | | 5 | 5 |
| | 19 | | | | | | | | | | | | | | | | | | | 5 |
| | 20 | | | | | | | | | | | | | | | | | | | |
| | 21 | | | | | | | | | | | | | | | | | | | |
| | 22 | | | | | | | | | | | | | | | | | | | |
| | 23 | | | | | | | | | | | | | | | | | | | |
| | 24 | | | | | | | | | | | | | | | | | | | |
| | 25 | | | | | | | | | | | | | | | | | | | |
| | 26 | | | | | | | | | | | | | | | | | | | |
| | 27 | | | | | | | | | | | | | | | | | | | |
| | 27 | | | | | | | | | | | | | | | | | | | |
| | 29 | | | | | | | | | | | | | | | | | | | |
| | 30 | | | | | | | | | | | | | | | | | | | |
| | 31 | | | | | | | | | | | | | | | | | | | |
| | 32 | | | | | | | | | | | | | | | | | | | |
| | 33 | | | | | | | | | | | | | | | | | | | |
| | 34 | | | | | | | | | | | | | | | | | | | |
| | 35 | | | | | | | | | | | | | | | | | | | |
| | 36 | | | | | | | | | | | | | | | | | | | |

| | | Chronological Age/Months | | | | | | | | | | | | | | | | |
|---|---|---|---|---|---|---|---|---|---|---|---|---|---|---|---|---|---|---|
| | | 20 | 21 | 22 | 23 | 24 | 25 | 26 | 27 | 28 | 29 | 30 | 31 | 32 | 33 | 34 | 35 | 36 |
| Skill | 1 | 1 | 1 | 1 | 1 | 1 | 1 | 1 | 1 | 1 | 1 | 1 | 1 | 1 | 1 | 1 | 1 | 1 |
| Level/ | 2 | 1 | 1 | 1 | 1 | 1 | 1 | 1 | 1 | 1 | 1 | 1 | 1 | 1 | 1 | 1 | 1 | 1 |
| Months | 3 | 1 | 1 | 1 | 1 | 1 | 1 | 1 | 1 | 1 | 1 | 1 | 1 | 1 | 1 | 1 | 1 | 1 |
| | 4 | 1 | 1 | 1 | 1 | 1 | 1 | 1 | 1 | 1 | 1 | 1 | 1 | 1 | 1 | 1 | 1 | 1 |
| | 5 | 1 | 1 | 1 | 1 | 1 | 1 | 1 | 1 | 1 | 1 | 1 | 1 | 1 | 1 | 1 | 1 | 1 |
| | 6 | 2 | 1 | 1 | 1 | 1 | 1 | 1 | 1 | 1 | 1 | 1 | 1 | 1 | 1 | 1 | 1 | 1 |
| | 7 | 2 | 2 | 2 | 2 | 1 | 1 | 1 | 1 | 1 | 1 | 1 | 1 | 1 | 1 | 1 | 1 | 1 |
| | 8 | 2 | 2 | 2 | 2 | 2 | 2 | 2 | 1 | 1 | 1 | 1 | 1 | 1 | 1 | 1 | 1 | 1 |
| | 9 | 2 | 2 | 2 | 2 | 2 | 2 | 2 | 2 | 2 | 2 | 1 | 1 | 1 | 1 | 1 | 1 | 1 |
| | 10 | 2 | 2 | 2 | 2 | 2 | 2 | 2 | 2 | 2 | 2 | 2 | 2 | 2 | 1 | 1 | 1 | 1 |
| | 11 | 3 | 2 | 2 | 2 | 2 | 2 | 2 | 2 | 2 | 2 | 2 | 2 | 2 | 2 | 2 | 2 | 1 |
| | 12 | 3 | 3 | 2 | 2 | 2 | 2 | 2 | 2 | 2 | 2 | 2 | 2 | 2 | 2 | 2 | 2 | 2 |
| | 13 | 3 | 3 | 3 | 2 | 2 | 2 | 2 | 2 | 2 | 2 | 2 | 2 | 2 | 2 | 2 | 2 | 2 |
| | 14 | 3 | 3 | 3 | 3 | 3 | 2 | 2 | 2 | 2 | 2 | 2 | 2 | 2 | 2 | 2 | 2 | 2 |
| | 15 | 3 | 3 | 3 | 3 | 3 | 3 | 3 | 2 | 2 | 2 | 2 | 2 | 2 | 2 | 2 | 2 | 2 |
| | 16 | 4 | 3 | 3 | 3 | 3 | 3 | 3 | 3 | 2 | 2 | 2 | 2 | 2 | 2 | 2 | 2 | 2 |
| | 17 | 4 | 4 | 3 | 2 | 2 | 2 | 2 | 2 | 2 | 2 | 2 | 2 | 2 | 2 | 2 | 2 | 2 |
| | 18 | 4 | 4 | 4 | 4 | 3 | 3 | 3 | 3 | 3 | 3 | 3 | 3 | 2 | 2 | 2 | 2 | 2 |
| | 19 | 5 | 4 | 4 | 4 | 4 | 3 | 3 | 3 | 3 | 3 | 3 | 3 | 3 | 2 | 2 | 2 | 2 |
| | 20 | 5 | 5 | 4 | 4 | 4 | 4 | 3 | 3 | 3 | 3 | 3 | 3 | 3 | 3 | 3 | 2 | 2 |
| | 21 | | 5 | 5 | 4 | 4 | 4 | 4 | 3 | 3 | 3 | 3 | 3 | 3 | 3 | 3 | 3 | 2 |
| | 22 | | | 5 | 5 | 4 | 4 | 4 | 4 | 3 | 3 | 3 | 3 | 3 | 3 | 3 | 3 | 3 |
| | 23 | | | | 5 | 5 | 4 | 4 | 4 | 4 | 4 | 3 | 3 | 3 | 3 | 3 | 3 | 3 |
| | 24 | | | | | 5 | 5 | 4 | 4 | 4 | 4 | 4 | 3 | 3 | 3 | 3 | 3 | 3 |
| | 25 | | | | | | 5 | 5 | 4 | 4 | 4 | 4 | 4 | 3 | 3 | 3 | 3 | 3 |
| | 26 | | | | | | | 5 | 5 | 4 | 4 | 4 | 4 | 4 | 3 | 3 | 3 | 3 |
| | 27 | | | | | | | | 5 | 5 | 4 | 4 | 4 | 4 | 4 | 4 | 3 | 3 |
| | 27 | | | | | | | | | 5 | 5 | 4 | 4 | 4 | 4 | 4 | 4 | 4 |
| | 29 | | | | | | | | | | 5 | 5 | 4 | 4 | 4 | 4 | 4 | 4 |
| | 30 | | | | | | | | | | | 5 | 5 | 4 | 4 | 4 | 4 | 4 |
| | 31 | | | | | | | | | | | | 5 | 5 | 4 | 4 | 4 | 4 |
| | 32 | | | | | | | | | | | | | 5 | 5 | 4 | 4 | 4 |
| | 33 | | | | | | | | | | | | | | 5 | 5 | 4 | 4 |
| | 34 | | | | | | | | | | | | | | | 5 | 5 | 4 |
| | 35 | | | | | | | | | | | | | | | | 5 | 5 |
| | 36 | | | | | | | | | | | | | | | | 5 | 5 |

It is not necessary to the practice of the invention to use these particular scales, however, as any suitable scale known to those having ordinary skill in the art may be substituted. It is important, however, that all ratings be based on a consistent measure to accurately portray functional gains.

Finally, the comments section of the clinical progress tracker 700 allows users to enter detail evaluation findings leading to the severity designation recorded in the status section and may be used to report specific test results. Examples of comments may include “Difficulty with problem solving and understanding idiomatic expressions” for a client with reasoning/logic problems; “Fluency characterized by 8-part word repetitions, prolongations of 1.5 to 2.0 seconds on vowel onset words and a total score of 20 indicating a moderate fluency disorder” for a client with fluency problems, and the like.

Examples 1-3 below provide specific examples of information that may be entered in the clinical progress tracker 700. In Example 1, a Functional Voice Assessment test was administered to the client, and the 7-point rating scale was used based on clinical judgment. In Example 2, an Expressive Speech Profile test was administered, and the 5-point percentage-based rating scale was used. In Example 3, the test administered is Clinical Evaluation of Language Fundamentals-4, and the 5-point standardized test rating scale was used.

| Function | Status | Comment |
|---|---|---|
| Posture | 5 | The client showed slightly constricted |
| | | sterno-pelvic alignment with forward |
| | | shoulder carriage restricting breath flow |
| | | management. |

### EXAMPLE 1

| Function | Status | Comment |
|---|---|---|
| Level 1 | 2 | Jane produced 32% of Standard English |
| (Isolated | | sounds on imitation including /p, b, m, t, |
| Sounds) | | d, n, s, ∫, t∫, h, i, a/. She was unable to |
| | | produce velars, complex palatals |
| | | involving airflow and voicing |
| | | coordination, semi-simple vowels or |
| | | blended vowels. |

### EXAMPLE 2

| Function | Status | Comment |
|---|---|---|
| Receptive | 3 | The total receptive language score was |
| Language | | 73 falling between −1.5 and −2 |
| Score | | standard deviations below normal. |
| | | Difficulties were noted following |
| | | concepts and directions with over 2 |
| | | critical elements, identifying word |
| | | classes, and understanding semantic |
| | | relationships. |

### EXAMPLE 3

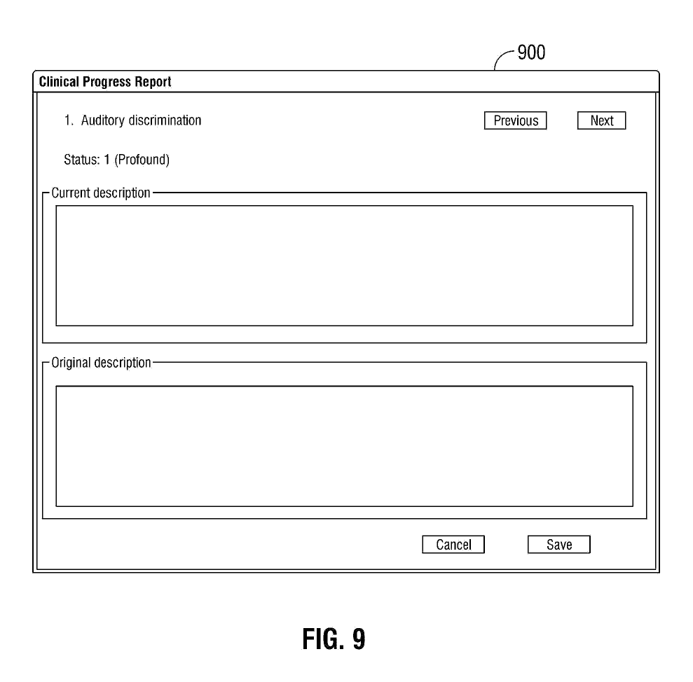

An edit button may be provided in some embodiments (see upper right-hand corner) to allow users to view and type from an enlarged view of the comment area, as shown in FIG. 9. This area itemizes the area users selected by numeric order and function on the clinical progress tracker 700. Users may toggle through the current descriptions and original descriptions by selecting “Previous” or “Next” from the upper right side of the screen. Users may cancel or save changes by clicking on the designated buttons at the bottom of the view.

A summary section may be provided in the clinical progress tracker 700 to allow users to enter a short summary of significant evaluation findings relating to functional deficits identified. In addition, users may also record any additional information leading to diagnostic conclusions in this field. An example of an entry in the summary section may include the following: “Test results showed problems with oral and facial tone and with range of motion limiting speech co-articulation and intelligibility. The client also demonstrated characteristics of anomic aphasia. Aphasic difficulties were characterized by decreased word fluency, auditory comprehension, word repetition, word naming, and reading and writing. These deficits caused problems understanding simple commands and communicating basic wants and needs.”

A speech and language diagnosis section in the clinical progress tracker 700 allows users to list specific diagnoses in order from most to least severe. Similarly, a prognosis section in the clinical progress tracker 700 allows users to give a short description of the client's potential for progress. Examples of information that may be entered in the prognosis section may include the following: good, fair, guarded, poor, and none known. As a practice tip, note that claims reviewers tend to view a prognosis of poor or guarded as suspicious. The claims reviewer may agree to pay for a therapeutic trial in this circumstance, as long as treatment activities are adequately justified on the report. Finally, the limitations section in the clinical progress tracker 700 allows users to provide a short description of any factor that might limit the client's progress, such as disorder severity, time since onset, functional level prior to the onset of the current condition, and the like.

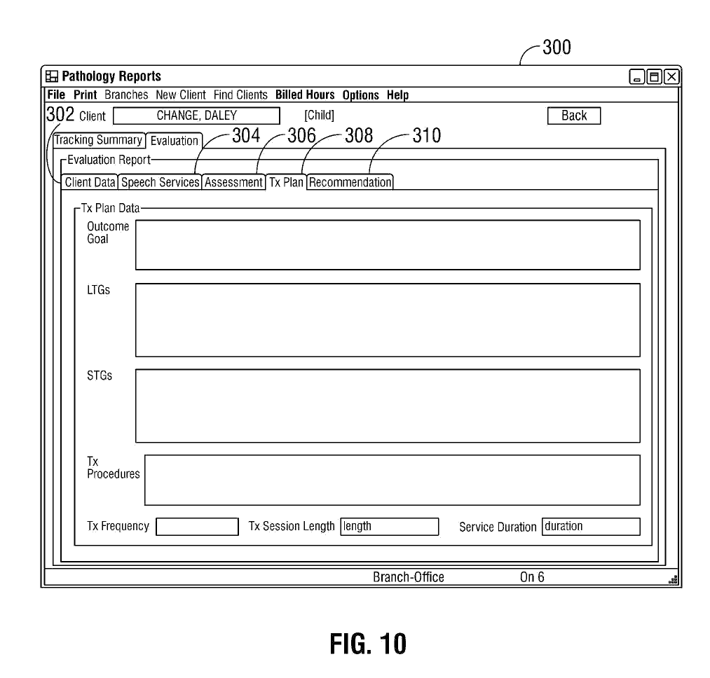

Once the justification for the diagnosis and treatment for the communication disorder has been established, a treatment plan may be entered by users in the treatment plan data section 308 of the evaluation report 300, shown in FIG. 10. In some embodiments, the treatment plan data section 308 may display several sections for goals, including an outcome goal, long-term goals, and short-term goals. These goals help identify the functional improvement that the client is expected to make over the course of treatment.

In writing goals, users should keep in mind that the goals are typically formulated to satisfy the requirements and obligations specified by the insurance companies or other funding sources. In general, goals should not be too general (e.g., “Improve word finding.”), should not be set based on clinical activities (e.g., “Will remember four objects with a 5 minute delay,” “Will repeat word lists with the initial /s/ sound with 90% accuracy”), and should be measurable and functional. Examples of the latter may include the following: “The client will eat a complete 6-oz serving of pudding in 10 minutes without coughing or choking by using compensatory strategies with minimal verbal cuing,” “The client will read and/or point to pictures on a restaurant menu to indicate what he and his wife had for the previous evening meal with 90% accuracy,” and the like. (See Golper, L. A., Brown, J. E., 2004, Business Matters: A Guide for Speech Language Pathologists, American Speech Language Hearing Association, Rockville, Md.)

The outcome goal should give a functional level goal describing the projected outcome of therapy. This goal should be easily understood by nurse practitioners reviewing the report for reimbursement purposes and by family members participating in conference activities. Examples of outcome goals may include the following: “The client will communicate basic physical and emotional needs with caregivers in the home setting,” “The client will demonstrate vocal health and stamina sufficient for return to her professional communication responsibilities as a lawyer,” “The client will demonstrate speech skills associated with normal adult speech,” and the like.

Long-term goals should be articulated in objective, measurable terms. Examples of long-term goals may include the following: “The client will produce /r/ in conversational speech with 95% accuracy,” “Test/retest information will show auditory processing skills within normal limits,” “The client will demonstrate the ability to produce 5-syllable esophageal speech on one injection of air in 9/10 trials,” “The client will demonstrate judgment and reasoning skills necessary to ensure safe swallowing on 10/10 trials,” and the like.

Short-term goals are typically not required as a part in an initial plan of care. Once generated, however, short-term goals may be cut [Ctrl-C] and pasted [Ctrl-P] into the goals section of a progress note (described later herein) for daily treatment documentation. Established short-term goals also may also be transferred electronically to the short term goal section of a progress report.

Short-term goals should generally contain three basic elements: 1) a desired functional result, 2) treatment activities related to the desired functional result, and 3) the success level. Examples of long-term goals may include the following: “The client will demonstrate improved use of compensatory speech strategies by achieving 90% intelligibility during a 5-minute conversation with the therapist,” “The client will demonstrate an increased ability to formulate expressive language by retelling paragraph information with 90% success,” “The client will demonstrate coordination of motor choice differentiation and sound production by selecting and producing the correct initial sound of a word, from a choice of 2 familiar sounds, with slight delays on 9/10 trials,” and the like.

In some embodiments, a goal bank (not expressly shown) may be provided, for example, in a database, such as the database 104 of FIG. 1. The goal bank may then be used as a repository of outcome, long-term, and short-term goals that were employed over time. Any assessment information associated with the goals, such as functional skills information or status information, may also be stored with the goals in the goal bank. Users may then access the goal bank and select appropriate goals for use with their individual clients.

In some embodiments, the treatment plan data section 308 may also include a treatment procedures area for allowing users to list procedural techniques selected to facilitate goal completion. Examples of treatment procedures that may be listed in this area include the following: (1) sound localization activities, eye contact reinforcement, Warner Feeding Checklist activities; (2) exercises for: oral and facial function, co-articulation, vocal control, respiratory control, bolus manipulation, and compensatory speech; and the like.

In some embodiments, a treatment frequency may be entered for specifying the desired number of treatment sessions, for example, on a per week basis. A treatment session length may also be entered for specifying the desired amount of treatment time per session, such as 30, 45, 60 minutes, and so on. Additionally, service duration may also be entered for specifying the projected length of service delivery. Users should estimate the length of service delivery as closely as possible. When in doubt about service delivery length, users should limit the projected service duration to six months or less, and justify subsequent service terms on a progress report (e.g., six months with review).

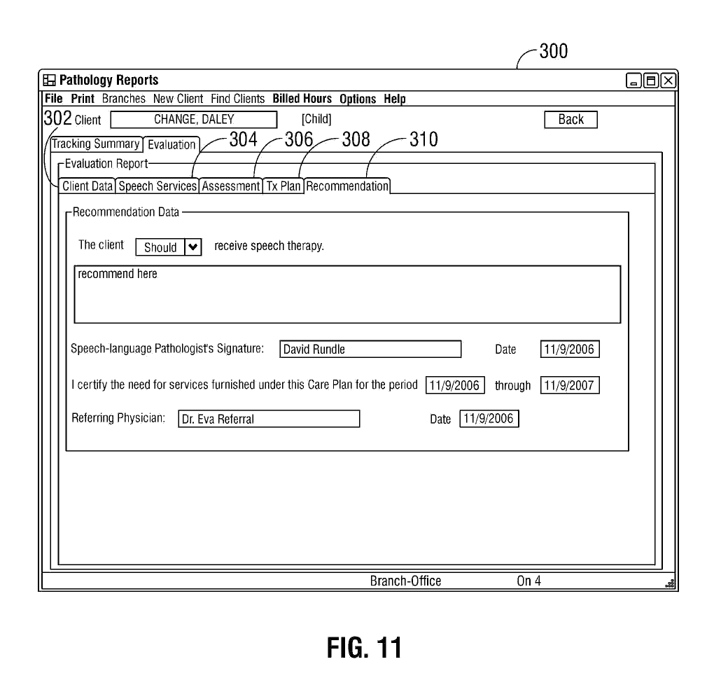

FIG. 11 illustrates the recommendation data section 310 of the evaluation report 300 according to the disclosed embodiments. In this section, users may specify whether the client should or should not be enrolled in therapy. This may be performed, for example, by clicking an appropriate box, selecting an appropriate dropdown menu item, or by freehand. A free write space area may be provided to allow users to provide any additional justification to claims reviewers about the need for speech service coverage and/or to document trial therapy results. Examples of information that users may provide in this free write space area include the following: “The client should be enrolled in therapy because trial therapy showed improved fluency utilizing suggested breath stream management techniques,” “The client should be enrolled in therapy because there was a change in mental status second to extension of a previous stroke,” and the like.

A speech-language pathologist's signature area may be provided for allowing users to enter a professional written or legal electronic signature along with the date therefor (which may be automatically populated). Users may double-click on this field to add a typed version of the evaluator's name. Note that legal documents typically require a handwritten or electronic representation of a handwritten signature. Licensing credentials should follow the signature in states where these characters are used to indicate certification.

In some embodiments, a certification may also be provided, such as: “I certify the need for services furnished under this Care Plan for the period ______ through ______.” Users may then enter the “from” and “through” dates in months, days and years (e.g., by double-clicking on each box). The “from” date should indicate the evaluation/care plan initiation date; the “through” date should encompass one progress reporting period and coincide with the report's specified service duration. Note that most insurance companies require an updated progress report at least every six months. Current Medicare regulations state that this period is every 10 visits or once during a 30-day billing period if there are not 10 sessions during a billing period. Requirements may vary from one insurance company to the next.

In some embodiments, a physician's signature may also be provided if applicable. This signature may act as an acknowledgement of the projected service duration listed in the certification statement and may serve as a prescriptive order for the designated service period. Users may enter NA (Not Applicable) if provider and insurer policies do not require a physician's signature. If the physician has or will sign a printed version of the report or provided a prescriptive order for services, users may simply enter “On file” in this field.

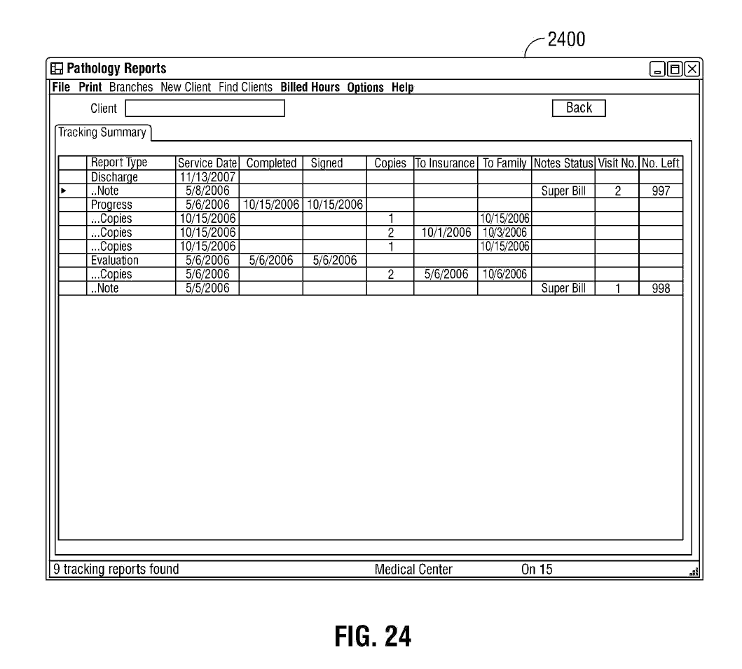

Once the above information has been entered and saved in the evaluation report 300, the progress tracking and caseload management application 220 allows users to begin tracking the progress of the client. To this end, the progress tracking and caseload management application 220 may provide progress notes that chronicle daily therapeutic activities. These progress notes also form the basis for all tracking summary events (described later herein with respect to FIG. 24). Such progress notes may be used to record information about the treatment of the client, beginning with the evaluation visit.

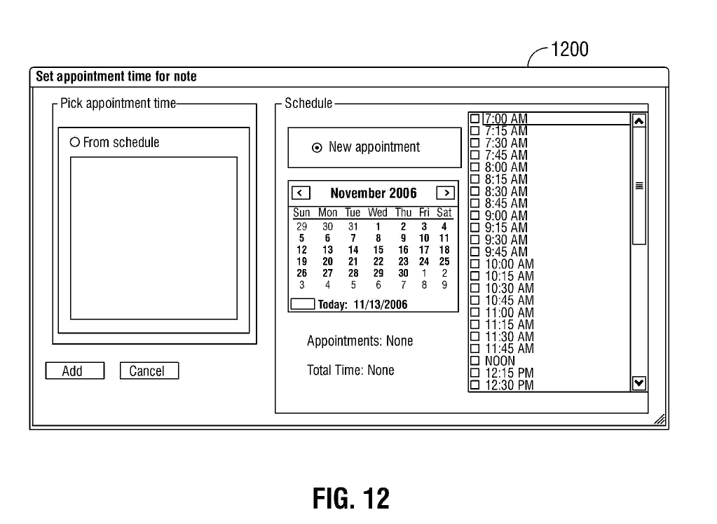

Referring now to FIG. 12, a scheduler 1200 is shown that may be used to initiate a progress note by first setting an appointment time for a treatment session. In some embodiments, the scheduler 1200 may be displayed by selecting an ‘Add Note’ option (not expressly shown) from the File Menu. Such a scheduler 1200 defines the day, time and the length of a treatment session, and also inserts a progress note onto the tracking summary (see FIG. 24). The scheduler 1200 shows the current calendar date and allows users set a new appointment for the progress note by selecting ‘New appointment’ at the top of the view. To create a note for a date other than the shown calendar date, users may arrow to the correct month and select the date of service, or select the correct date on the monthly calendar. After selecting the correct service date, users may click on the boxes defining the treatment duration by checking consecutive boxes or by checking beginning and ending 15-minute boxes, as shown.

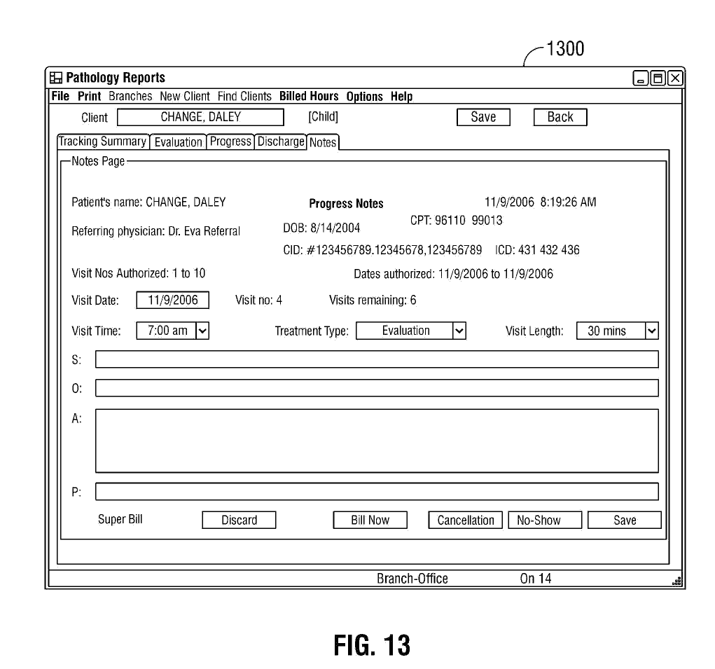

Once the date and session length parameters are selected, users may click on an ‘Add’ button located in the lower left-hand corner of the portion of the scheduler 1200 called ‘Pick appointment time.’ This causes the clinical progress tracking and caseload management application 220 to generate a progress note and to place the note into the tracking summary (see FIG. 24). The new progress note appears, as shown in FIG. 13, reflecting the data entered from the scheduler 1200. Users may then review all the listed information and select the treatment type for the note (from the dropdown menu), including evaluation, diagnostic therapy, therapy, consultation, and the like.

FIG. 13 illustrates an exemplary progress note 1300 according to the disclosed embodiments. To capture information concerning the treatment session, the progress note 1300 may employ a SOAP notation, where (S) stands for subjective statement, (0) stands for an objective statement, (A) stands for an assessment of clinical findings and results, and (P) stands for a plan. Each note following the previous note may be initially displayed as a copy of the previous note, thus providing users with continuity from session to session.

With respect to the subjective statement (S), users may enter a subjective statement of the client's condition on the date of service, and/or give descriptions of any changes in the client's physical or emotional status directly affecting treatment results. Users should try to avoid using words such as unmotivated or uncooperative, which are red flags to claims reviewers. Examples may include: client was cooperative, client required redirecting to focus on tasks, client responses were alert and focused, and the like.

With respect to the objective statement (O), users may provide an objective statement about daily treatment objectives. For this statement, the first progress note associated with an evaluation visit may be automatically populated with the tests that were administered, as indicated in the tests administered section of the clinical progress tracker 700 of the evaluation report 300. Data may be edited freely, but subsequent objective statements should reflect daily treatment goals or a general statement about service period treatment goals. Examples may include:

1. Treatment activities focused on expanding production of /s/ into phrases and short sentences.

2. The goal for this service period is to improve transfer of airflow management, easy onset phonation and proper projection techniques into professional voice use situations.

3. Service period goals focus on cognitive association strategies to improve word finding skills and on compensatory speech strategies to increase intelligibility.

With respect to the assessment (A), users may write an assessment of findings related to daily treatment activities that coincide with selected service period goals. Short term goals may be copied and pasted into this section. Goals should always contain three basic elements: 1) a desired functional result, 2) a treatment activity related to the desired functional result, and 3) the success level. Examples may include the following:

1. To improve client's ability to recall words needed to express simple thoughts, he named four categorical items within 30 seconds on 6/10 trials and completed word association activities with 70% success.

2. As a precursor to isolated sound production, client identified his lips, tongue and voice with verbal cues and 75% success and onset his voice on command on 3/5 trials.

3. To prepare the client for a safe return to professional voice use responsibilities, she demonstrated use of proper airflow management skills during conversational activities with 90% success, used proper vocal projection style during a 10 minute conversation with 95% success, and showed awareness and self-correction of harsh vocal onset throughout the session.

An important part of creating a total client picture includes chronicling all events related to treatment. To this end, users may use the assessment (A) section of the SOAP note to describe interactions and discussions with caregivers and others involved in a client's care. Homework assignments should be listed either in the assessment (A) section of the SOAP notes or in the subsequent plan (P) section.

The plan (P) section allows users to describe plans for services, such as continue therapy, continue therapy and continue home practice focused on ______, discharge from therapy—treatment completed, and the like.

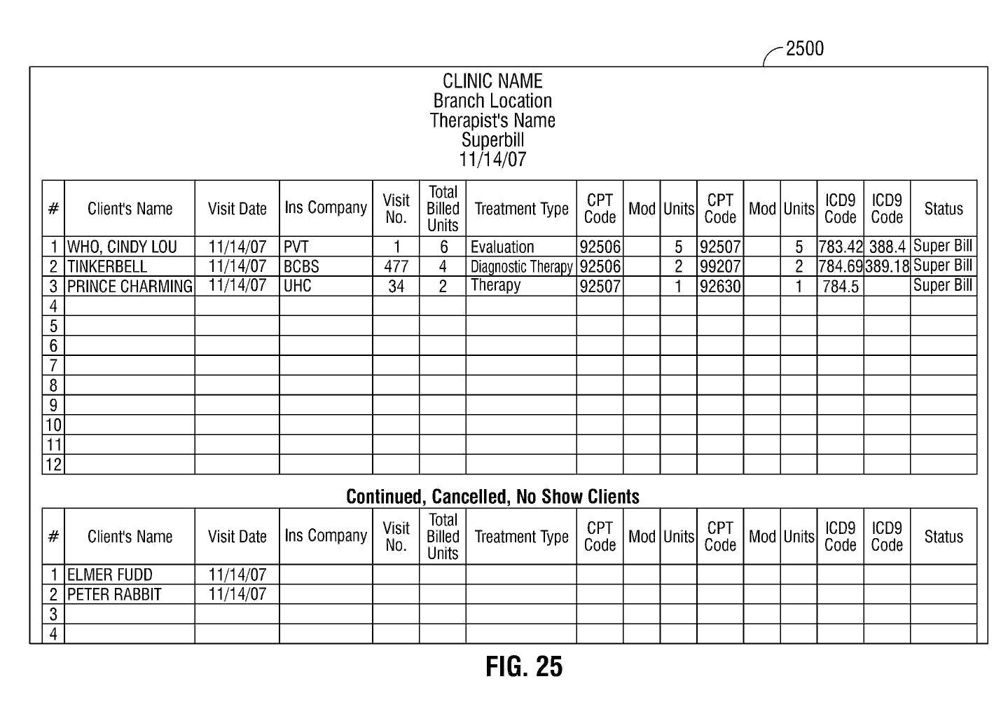

Referring still to FIG. 13, users may select the ‘Save’ button to save the content of the progress note 1300 for future editing. A saved progress note 1300 may then be used to populate the tracking summary (see FIG. 24) as mentioned above and also the billed hours log (described later herein with respect to FIG. 25) for further progress tracking and may be denoted by ‘Continue’ therein.

The progress note 1300 may be finalized by selecting a ‘Bill Now’ button (the ‘Save’ function does not finalize the progress note 1300 for billing purposes). The ‘Bill Now’ button causes a new progress note 1300 to be created on a subsequent service date and finalizes the current progress note 1300 such that users may no longer make changes. The progress tracking and caseload management application 220 may then list the completed progress note 1300 as ‘Super Bill’ on the tracking summary, add the visit to the total visit number and also to the list of daily billed hours. Note that the progress notes 1300 are time-sensitive such that the ‘Bill Now’ function will not accept a future note so that a note generated prior to the scheduled appointment time may only be billed after the scheduled appointment time has passed.

Although not expressly shown, in some embodiments several dialogue boxes may appear after ‘Save’ or ‘Bill Now’ has been selected by users. These dialog boxes allow users to modify various items of information previously entered. For example, a dialogue box may appear that ask users: “Do you want to change the CPT codes?” Another dialog box may ask users: “Do you want to change the ICD9 code?” Users may then indicate ‘Yes’ to change a code or codes, at which point they may be given an opportunity to change the CPT or ICD9 codes, respectively. Selecting ‘No’ takes users to the next dialogue box, while selecting ‘Cancel’ returns users to the note for further editing. Yet another dialog box may ask users: “Do you still want to bill this note?” Selecting ‘Yes’ adds the progress note to the tracking summary, while selecting ‘No’ returns users to the original note.

Clicking on a ‘No Show’ button indicates the client failed to acknowledge a scheduled appointment. The tracking summary may then lists the missed visit as a ‘No Show’ for the service date of the progress note. A ‘No Show’ appointment is not recorded on the billed hour form according to be disclosed embodiments. Clicking on a ‘Cancellation’ button indicates a cancelled appointment on the tracking summary and billed hours log. The tracking summary subsequently lists the visit opportunity as a ‘Cancellation’ for the service date of the note. A ‘Cancellation’ does not affect the visit number or the units on the billed hours form according to the disclosed embodiments.

Clicking on a ‘Discard’ box in the lower left-hand corner of the progress note 1300 removes a note. The next time that client's file is opened to create a new progress note 1300, the discarded note appears in a highlighted box marked ‘Pick appointment time’ on the scheduler 1200. A ‘From schedule’ box on the scheduler 1200 may then show there is an appointment remaining on the schedule corresponding to the time of the discarded note. Selecting “remove” at the bottom of the ‘Pick appointment time’ box causes a dialog box to appear asking if users want to remove the appointment from the schedule. Select “yes” to remove the appointment or “no” to return to the tracking summary. The note may be reinserted by clicking on the discarded note in ‘Pick appointment time’.

Selecting ‘Back’ from the upper right-hand corner of the view returns users to the tracking summary (see FIG. 24).

Although not expressly shown, an appointments option on the Options menu allows users to reserve an appointment time on the scheduler 1200 in preparation for adding a progress note. Users first open the client's file for whom they wish to schedule an appointment, then select “Options” from the toolbar and click on ‘Appointments’ and select ‘Add,’ and the scheduler 1200 appears, allowing users to select an appointment date and time.

Users may create a progress note after scheduling an appointment from the Options menu by clicking ‘Add Note’ under the File menu. A ‘Pick appointment time’ area and a ‘From schedule’ box show there is an appointment time on the schedule. Users should check to make sure the date, time and session length are correct, then select “Add” from the lower left side of the ‘Pick appointment time’ box to create a note. Selecting “Remove” at the bottom of the ‘Pick appointment time’ box removes the appointment from the schedule. A dialog box may appear asking if users want to remove the appointment from the schedule. Selecting “Yes” removes the appointment and “No” returns users to the tracking summary.

Cancelling a scheduled appointment may be achieved by selecting the “Cancel” button at the bottom of the ‘Pick appointment time’ section, which returns users to the tracking summary without creating a note.

Users may create a progress report by opening the client's file for whom they wish to create the report. Select “Add Report” from the File menu. When the report categories appear, users may identify the progress report and click on it.

In some embodiments, a progress report designation appearing in grey font means the previous report was not finalized. In that case, users may open the previous report, finalize it, then create a new progress report.

As mentioned above, multiple reports may share the same five data sections, including client data, speech services data, assessment data, treatment plan data and recommendations. Thus, the format of the progress report may be identical to the format of the evaluation report, described with respect to FIGS. 3-11, as well as the format of the discharge summaries. The reader is referred to FIGS. 3-11 and the description associated therewith for information concerning the data sections. To the extent any data (e.g., client name, date of birth, gender, social security number, etc.) was entered previously via another report, that data may be used to automatically populate subsequent fields for the same data. Users may change any automatically transferred data by clicking on the field and manually entering the data. Appropriate data may be entered in all available blanks to finalize a report.

FIG. 14 illustrates an exemplary progress report 1400, particularly the client data section 1402 therein, according to the disclosed embodiments. The progress report 1400 may also include a speech services data section 1404, an assessment data section 1406, a treatment plan data section 1408, and a recommendation section 1410. Many of the fields in the client data section 1402 may already be populated because they have been previously entered via the evaluation report 300. The fields include client name, date of birth, age, sex, social security number (SS #)/client identification (CID), insurance, CPT code, medical diagnoses, ICD9 code, and precautions.

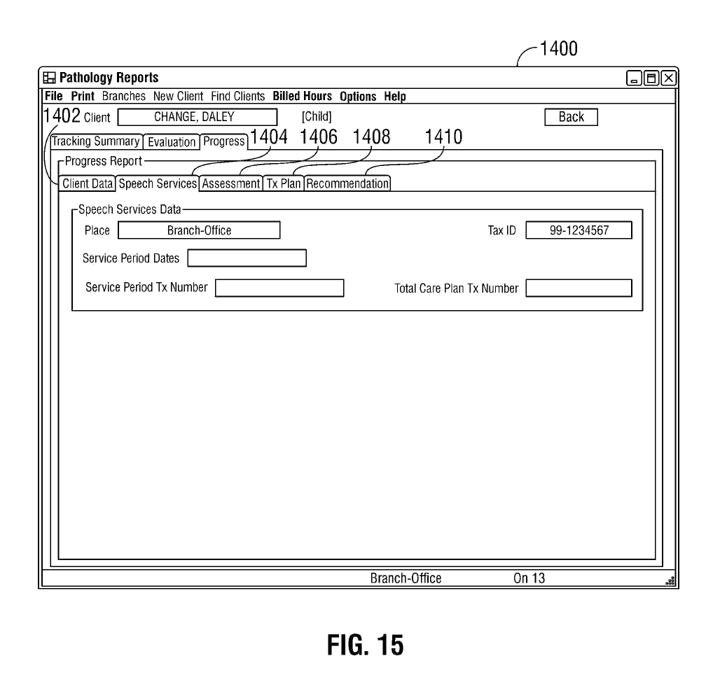

FIG. 15 illustrates the speech services data section 1404 of the progress report 1400. Here, the place and tax ID have been automatically pre-filled, but the service period dates, service period treatment number, and total care plan treatment number still need to be entered. Users may then enter the calendar period covered by the report, such as Jun. 1, 2007 thru Dec. 1, 2007, or the like. Dates should coincide with the certification dates listed in the recommendation data section of the previous report. The total number of treatment sessions recorded during the designated service period (see visit number on the tracking summary in FIG. 24) may then be entered in the service period treatment number field. The total number of treatment sessions recorded from the initiation of the continuous care plan through the end of the designated service period on the report may then be entered in the total care plan treatment number field (see visit number on the tracking summary in FIG. 24).

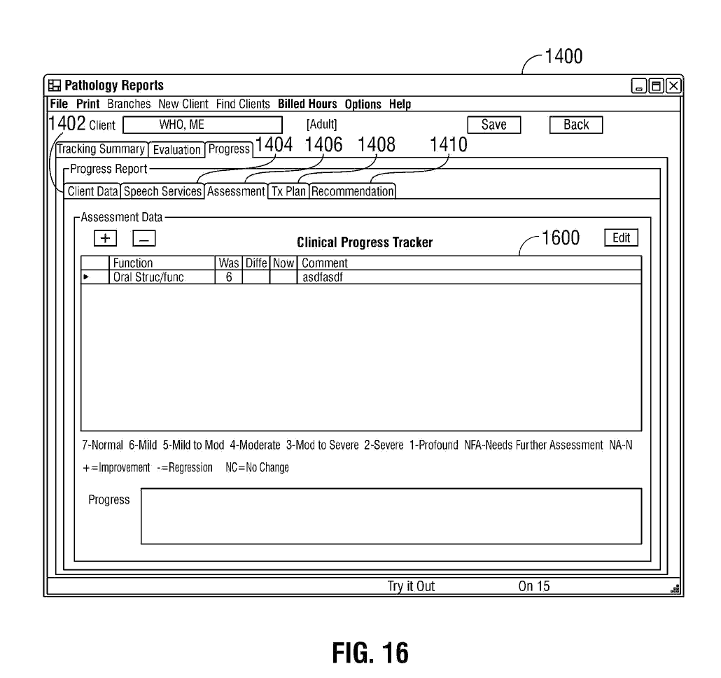

FIG. 16 illustrates the assessment data section 1406 of the progress report 1400. As alluded to above, the purpose of the assessment data section of the progress report is to provide a descriptive picture of client progress supported by clinical data. To this end, the assessment data section 1406 may include a clinical progress tracker 1600 for tracking a progress of the client. Progress may then be reported numerically in a status section of the clinical progress tracker 1600 and also through written remarks in a comment section and progress section thereof. This allows the assessment data 1406 section to tie previously reported continuous care plan information to the client's functional status at the end of the current progress reporting period. Such an arrangement lets users compare and quantify any progress the client may have made over time, and to attach monetary value to the progress based on the cost of the treatment. Treatment may then be derived and/or modified (e.g., number of services, length of each session, etc.) using the comparison, quantification, and cost information.

In some embodiments, the clinical progress tracker 1600 may be similar to the clinical progress tracker 700 of FIG. 7 insofar as it includes a function field and a comments field. Indeed, data from the function field of the clinical progress tracker 700 of FIG. 7 may be used to automatically populate the function field of the clinical progress tracker 1600 of FIG. 16. And as before, the comment field may serve as a space to detail service period treatment results (keeping in mind the importance of reporting treatment progress in a comparative data format).

However, in place of the status field of the clinical progress tracker 700 of FIG. 7, the clinical progress tracker 1600 of FIG. 16 includes progression fields that show the previous status of the client, the status of the client at the end of the service period covered by the report, and any clinical progress the client has made. In some embodiments, the previous status may appear in a “Was” column, the current status in a “Now” column, and any difference may appear in a “Different” column. The “Was” column be automatically populated from the status field of the clinical progress tracker 700 FIG. 7, and the “Different” column may be automatically populated based on the number placed in the “Now” column. Examples of the clinical progress tracker 1600 of FIG. 16 are shown below in Examples 3 and 4 where, as before, 7=Normal, 6=Mild, 5=Mild to Moderate, 4=Moderate, 3=Moderate to Severe, 2=Severe, 1=Profound, and NC=No Change.

| | | Dif- | | |
|---|---|---|---|---|
| Function | Was | ferent | Now | Comment |
| Oral | 4 | + | 6 | The client improved her ability |
| structures | | | | to complete oral motor |
| and | | | | activities from the ability to |
| functions | | | | complete 6/10 skills to the |
| | | | | ability to complete 8/10 skills. |
| Word fluency | 3 | NC | 3+ | Treatment data showed an |
| | | | | improvement in word recall |
| | | | | time from a previously |
| | | | | reported 5 second delay for |
| | | | | recall of basic nouns to a 3 |
| | | | | second delay for 25 selected |
| | | | | vocabulary words. |
| Intelli- | 4 | + | 5 | Monthly test/retest analysis of |
| gibility | | | | a 5 minute conversational |
| | | | | speech sample showed an |
| | | | | increase in speech intelligibility |
| | | | | from the 65% to the 80% level. |

### EXAMPLE 3

| | | Dif- | | |
|---|---|---|---|---|
| Function | Was | ferent | Now | comment |
| Oral | 5 | − | 4 | Retest results following the |
| structures | | | | client's extended stroke |
| and | | | | (Aug. 31, 2007) resulted in a |
| functions | | | | decrease in her ability to |
| | | | | lateralize her tongue and |
| | | | | elevate the tongue tip. |

### EXAMPLE 4

Any progress the client has made may be reported in a progress area of the clinical progress tracker 1600. Users should make a progress statement followed by a summary statement of functional gains, and further followed by a so-called “next step” statement. The progress section is also a good place to put any total score information from tests or retests as a general statement of progress. Total score should be discuss comparatively if possible. Examples of progress statements may include:

1. Service period improvements included an increase in oral motor control, naming tasks and speech intelligibility. These improvements resulted in an increase in the client's ability to intelligibly express thoughts and concerns to her family and caregivers. She is now ready to begin work on using cognitive association strategies to improve word finding skills and using compensatory speech strategies to increase her intelligibility with unfamiliar listeners.

2. Functional Voice Assessment retest results supported the positive impact of treatment focus on vocal care, easy onset phonation and head-voice resonance. Test results showed an increase in the clients overall vocal range from 450 Hz to 650 Hz with an increase in vocal volume from 32 dB to 40 dB during conversational speech. The client is now able to use his voice to communicate during daily activities with decreased vocal fatigue and increased vocal control. The next step is to improve his ability to transfer airflow management, easy onset phonation and proper projection techniques into his professional speaking responsibilities as a university professor.

3. Clinical gains showed improvement in the application of “th” into structured, familiar contexts. The client now demonstrates improved speech clarity during word naming tasks. Upcoming treatment will focus on application of “th” into phrase and sentence length utterances.

Note that “next step” statements may be copied and pasted into the “O” section of the SOAP notes, discussed previously, to serve as the objective for the ensuing reporting period. Examples summary statements and next steps statements may include:

Summary statement: She is now ready to begin work on using cognitive association strategies to improve word finding skills and compensatory speech strategies to increase her intelligibility with unfamiliar listeners.

Next step statement: The focus of service period treatment activities is on cognitive association strategies and compensatory speech strategies to improve word finding and speech intelligibility.

Summary statement: The next step is to improve his ability to transfer airflow management, easy onset phonation and proper projection techniques into his professional speaking responsibilities as a university professor.

Next step statement: Treatment activities include airflow management, easy onset control, and proper vocal projection to improve voicing during professional speaking responsibilities.

Summary statement: Upcoming treatment will focus on application of “th” into phrase and sentence length utterances.

Next step statement: Treatment activities focus on application of “th” into phrase and sentence length utterances.

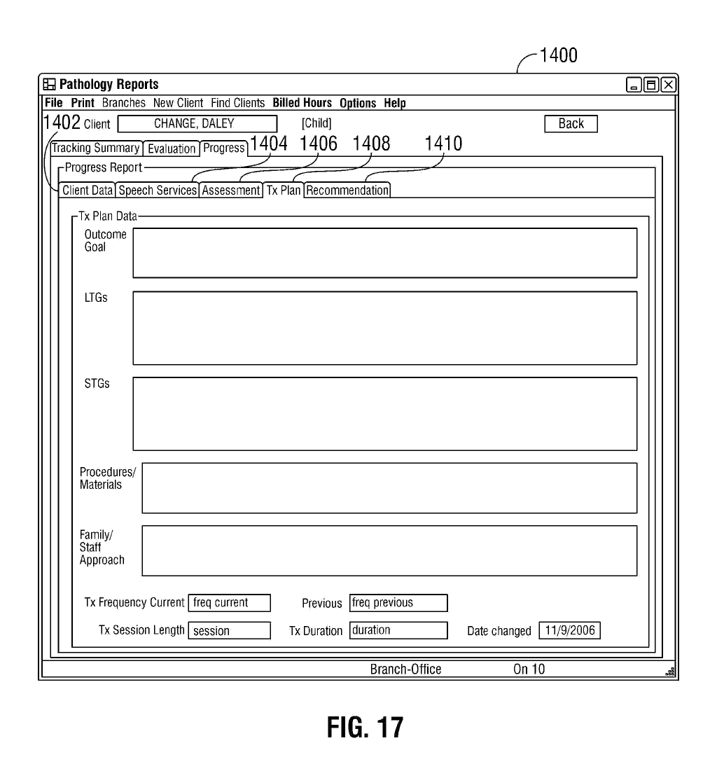

Using the overall scheme discussed above, users may weave information from the clinical progress tracker 1600 into one or more goals for the client, as shown in FIG. 17. In preparing goals, it is important to write goal and activity results that reflect progress and create a clear understanding about functional gains for readers, including insurance claims reviewers (usually nurse practitioners), physicians, clients and family members. Users should recognize that the most effective statements use consistent clinical measures. Tools that may be used for determining progress in a consistent manner include standardized test and retest data (the preferred method), and accurate objective clinical measurements. In addition, comparative statements should be used to substantiate objective progress toward established goals. Users should remember to describe the functional impact of service period gains, develop “next step” or “upcoming” statements, and tie upcoming skill focus to short term goals.

Examples of comparative statements for supporting insurance coverage may include:

1. Month test/retest results from the immediate memory subtest of the Ross Information Processing Assessment showed that Margaret improved her score from the 70% to the 80% level.

2. During the current service period, the client demonstrated an increase in her vocal range from a previously reported 6 steps to a current 10 steps.

3. Christopher improved his production of “th” from the 60% (6/10) level in the initial position of words to the 70% (7/10) level in the initial, medial and final position of words with cues.

Example of functional progress statements based on the results of treatment may include:

1. The client is now able to retain two-element facts long enough to write key ideas for future reference.

2. Functional voice improvements included decreased vocal strain and improved speech prosody.

3. As a result of treatment, the client produces “th” in both familiar and unfamiliar contexts with greater ease and coordination.

Examples of inadequate statements that do not describe progress or support insurance coverage may include:

1. The client showed consistent responses. (There is no statistical support for this statement.)

2. The client is able to inject air 80% of the time. (There is No data comparison.)

3. Auditory comprehension improved from the moderate to mild level. There is (insufficient objective information.)

Examples of upcoming goal statements based on treatment results may include:

1. Upcoming treatment will focus on increasing the length of time Margaret can retain two-element facts.

2. The client is ready to begin work using a soft vocal attack to ease vocal fold contact pressure during voicing activities.

3. The client is ready to begin using “th” in longer phrases and short sentences.

As can be seen in FIG. 17, in some embodiments, the treatment data section 1408 of the progress report 1400 may include fields for entering goals. For example, there may be fields for outcome goal, long-term goals, and short-term goals. These goal fields may be similar to their counterparts in the treatment data section 308 of the evaluation report 300, shown in FIG. 10. Indeed, in some embodiments, data from the treatment data section 308 of the evaluation report 300 may be used to automatically populate the outcome goal, long-term goals and short-term goals of the progress report 1400. Any completed goals may be marked and deleted from subsequent progress reports.

The treatment data section 1408 of the progress report 1400 may also include fields for entering treatment information. For example, the treatment data section 1408 may include a treatment procedures field, a treatment frequency field, a treatment length field, and a service duration field. Data from the counterpart to these fields in the evaluation report 300 may be automatically transferred to these fields. Users may adjust treatment procedures to accommodate service period objectives as needed. Examples of procedural techniques that may be entered may include sound localization activities, eye contact reinforcement, Warner Feeding Checklist activities, and the like. Users may also mention exercises for oral and facial function, co-articulation, vocal control, respiratory control, bolus manipulation, and compensatory speech.

Although not expressly shown, in some embodiments, a field may be provided for entering comments to family and/or staff members. Users may list, for example, ways the family and/or staff can enhance communicative interactions and therapy techniques, such as by presenting all information in short, simple sentences; encouraging verbal responses; reinforcing appropriate tongue placement; and the like. Other examples may include ignoring crying behavior, reinforcing attending behavior, encouraging vowel vocalizations, and the like.

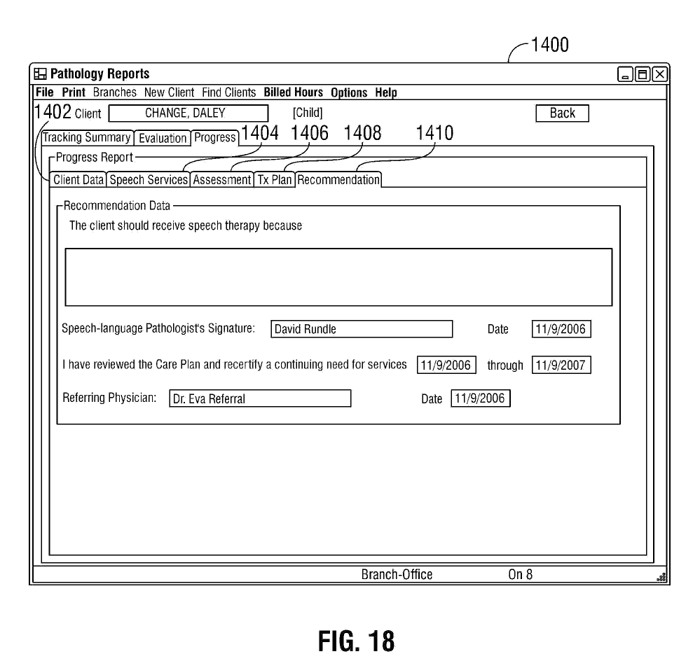

FIG. 18 illustrates an exemplary recommendation section 1410 of the progress report 1400 according to the disclosed embodiments. This section allows users to recommend whether the client should or should not continue to be enrolled in therapy. Examples of recommendations may include:

1. The client should be enrolled in therapy because he/she is making significant progress towards accomplishing long-term goals.

2. The client should be enrolled in therapy for increasing numbers of visits because he/she demonstrates clearing mental status and a subsequent ability to tolerate more frequent therapy sessions. This will expedite progress towards long term goal accomplishment.

Areas may also be provided for users to enter a speech-language pathologist's signature, date, and a certification that may be needed. An example of a certification may be as follows: “I certify the need for services furnished under this Care Plan for the period ______ through ______. The “from” date should indicate the evaluation/Care Plan initiation date, and the “through” date should encompass one progress reporting period and coincide with the report's specified service duration.

Referring now to FIG. 19, in some embodiments, a discharge summary 1900 may also be created in addition to the evaluation report 300 and the progress report 1400 discussed above. This may be done, for example, by opening the client's file for which users wish to create the report, and selecting “Add Report” from the File menu. Report categories may appear from which users may identify the discharge summary and click on it. A discharge summary designation appearing in grey font means the previous report was not finalized. Users may open the previous report, finalize it, and then create the discharge summary.

In general, the discharge summary shares the identical format with the evaluation report and progress report. Thus, the discharge summary may have the same five data sections as the other reports, including client data section 1902, speech services data section 1904, assessment data section 1906, discharge plan section 1908, and recommendations section 1910. Users may click on the appropriate tab for each section to activate the desired window for that section. Data entered in a previous report may be automatically populated to their respective fields in the discharge summary 1900. Thus, as can be seen in FIG. 19, the client data section 1902 has been automatically populated with client name, date of birth, age, sex, social security number/client identification number, CPT codes, medical diagnoses, ICD9 codes, and the like.

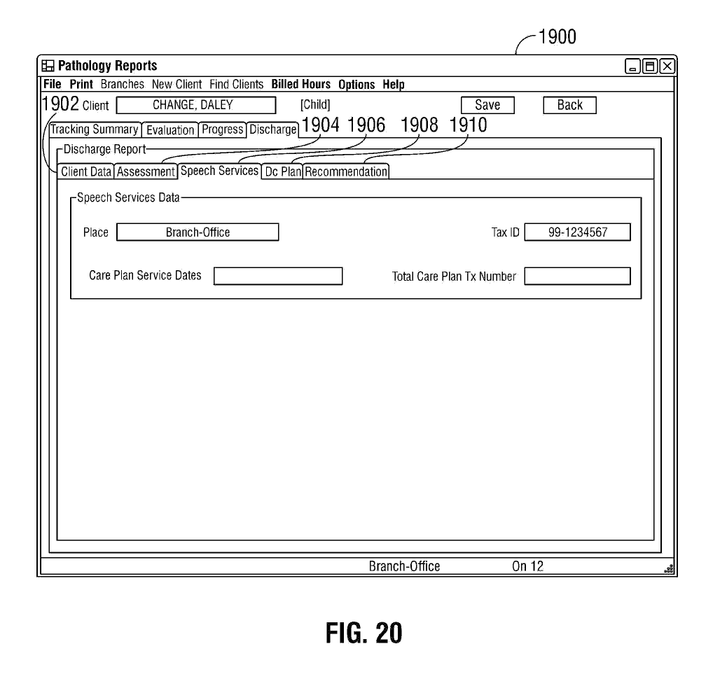

FIG. 20 illustrates an example of the speech services data section 1906 of the discharge summary 1900. As can be seen, the place and tax ID for this section has been transferred in from previous reports. A care plan dates field allows users to enter the dates of the continuous care plan service period, such as Jun. 1, 2007 thru Mar. 31, 2008. This service period begins with the evaluation and ends with the date of discharge. A total care plan treatment number field allows users to enter the total number of treatment sessions recorded from the initiation of the continuous care plan through the ending service date.

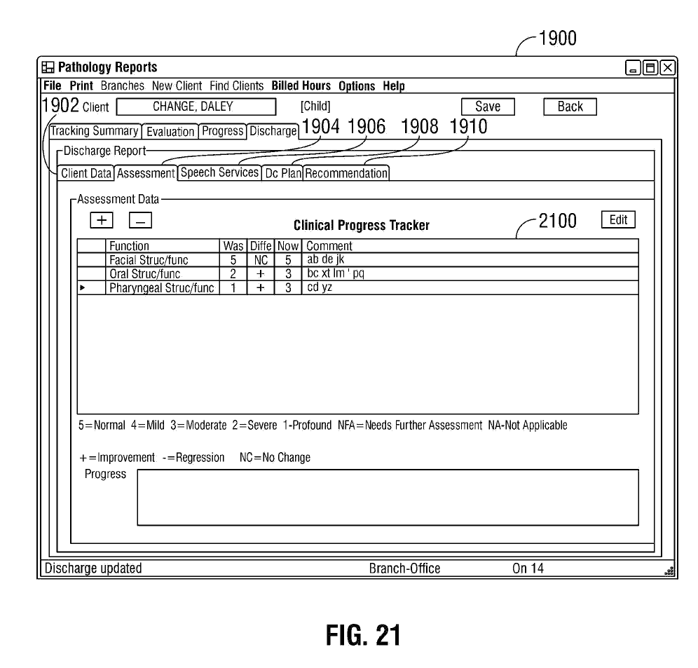

FIG. 21 illustrates an example of the assessment data section 1904 of the discharge summary 1900. The purpose of the assessment data section 1904 is to provide a descriptive picture of client progress throughout the continuous care plan. To this end, the assessment data section 1904 may include a clinical progress tracker 2100, similar to the clinical progress tracker 700 (see FIG. 7) and the clinical progress tracker 1600 (see FIG. 16) of the previous reports. Users may follow the same data entry procedures that were described for clinical progress tracker 1600 of FIG. 16. That is, a “Was” column may be provided to reflect the client's functional status at the time of the initial evaluation, a “Now” column may be provided to report the client's functional status at the time of discharge, and a “Different” column may be provided to represent the change (which may be automatically calculated).

As for the other fields, the function field may be automatically populated with data from the evaluation report 300. The comment area serves as a space to detail service period treatment results. Users should keep in mind the importance of reporting treatment progress in a comparative data format. Comparisons should reflect the changes in communication from the time of the initial evaluation to the time of discharge. Reporting should be substantiated by the reason for the setback. Examples are provided below in Examples 5 and 6 where, as before, 7=Normal, 6=Mild, 5=Mild to Moderate, 4=Moderate, 3=Moderate to Severe, 2=Severe, 1=Profound, and NC=No Change.

| | | Dif- | | |
|---|---|---|---|---|
| Function | Was | ferent | Now | comment |
| Oral | 4 | + | 6 | The client improved her ability |
| structures | | | | to complete oral motor |
| and | | | | activities from the ability to |
| functions | | | | complete 6/10 skills to the |
| | | | | ability to complete 9/10 skills. |
| Word fluency | 3 | NC | 6 | Treatment data showed an |
| | | | | improvement in word recall |
| | | | | time from a 5 second delay for |
| | | | | recall of basic nouns to slight |
| | | | | processing hesitations during |
| | | | | question formulation. |
| Intelligi- | 4 | + | 6 | Test/retest analysis of a 5 |
| bility | | | | minute conversational speech |
| | | | | sample showed an increase in |
| | | | | speech intelligibility from the |
| | | | | 65% to the 95% level. |

### EXAMPLE 5

| | | Dif- | | |
|---|---|---|---|---|
| Function | Was | ferent | Now | comment |
| Oral | 5 | − | 4 | Retest results following the |
| structures | | | | client's extended stroke |
| and | | | | (Aug. 31, 2007) resulted in a |
| functions | | | | decrease in her ability to |
| | | | | lateralize her tongue and |
| | | | | elevate the tongue tip. |

### EXAMPLE 6

A progress field allows users to provide a short summary of pre- and post-care plan findings and the resulting communication improvements relating to functional progress. This field provides a place to put any total score information from tests or retests as a general statement of progress. Users should use comparative verbiage to thread information from the clinical progress tracker 2100 to the progress section and should remember to compare evaluation to discharge statistics. Examples of progress statements may include the following:

1. Initial test results showed dysarthria and anomic aphasia characterized by decreased intelligibility, verbal fluency, auditory comprehension, repetition skills, reading and writing. Long term goals focused on increased speech intelligibility and on improvement of Western Aphasia Battery (WAB) test scores. Treatment results showed an increase in intelligibility from the 75% to the 90% level. WAB test/retest results showed an improvement in the Aphasia Quotient from 83 to 91, and an improvement in the Cortical Quotient from the 84 to 93. The client is now able to use her communication skills to successfully interact with family, friends and community workers. She continues to utilize some verbal paraphasias, and to have mild difficulty with verbal fluency skills and comprehension of complex 3-stage commands.

2. Test/retest laryngoscopic examinations performed by the referring physician showed total resolution of the client's bilateral vocal fold nodules. Dr. Speech test/retest results showed an increase in fundamental speaking frequency from 176 Hz to 225 Hz, and an improvement in the client's overall vocal range from 620 Hz to 1080 Hz. As a result of therapy, the client returned to normal voice use in both work-related and social settings.

3. The client made functional progress toward all long-term goals. Initial results of the Bedside Swallowing Evaluation and the Modified Barium Swallow Test showed . . . . Results of the Modified Barium Swallow retest from (date) showed safe oral intake of liquid, paste and cookie consistency foods when utilizing posturing and protective swallow techniques. The client met his outcome goal by demonstrating the ability to utilize safe oral intake for one full meal.

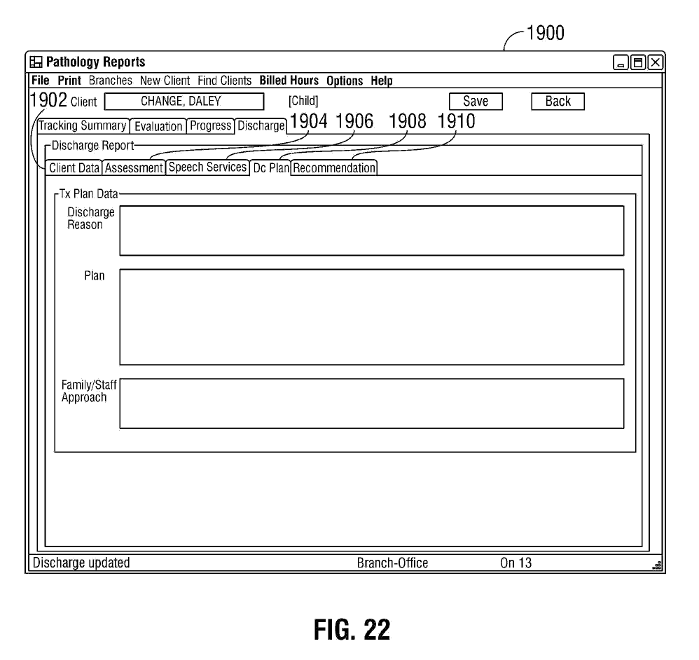

FIG. 22 illustrates an exemplary discharge plan section 1908 of the discharge report 1900. Here, a discharge reason field may be provided for allowing users to enter the reason for discharge from treatment, such as goals met, two month performance plateau, client discharged to long term care facility, and the like. A plan field may be provided for allowing users to discuss any pertinent discharge and follow up plans. Examples may include:

1. Discharge to the public schools. Release care plan documents to the mother.

2. Client to continue home practice 1×/day for 30-minutes to assist in maintenance of current functional levels. Exercises to include . . . .

3. Discharge to home. Request a physician's order for continued out-client speech services with an emphasis on the current remediation approach.

A field may be provided for entering comments to family and/or staff members. Users may then list suggestions to the family/staff to facilitate communicative interactions and to promote carryover of treatment objectives. Examples may include: continue family support; assist with continued home practice; reinforce proper use of fluency techniques through verbal praise, and the like.

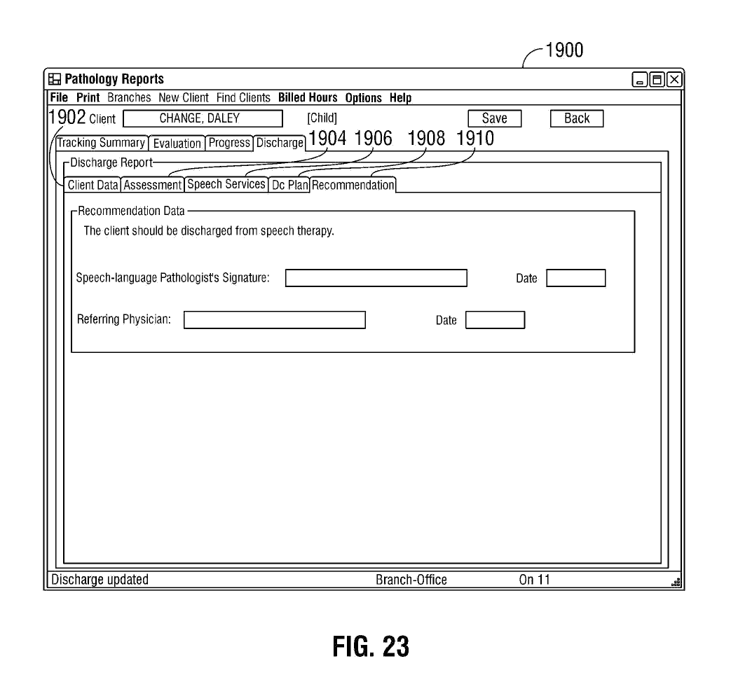

FIG. 23 illustrates an exemplary recommendations section 1910 of the discharge report 1900. This section basically notifies a reviewer that the client is being discharged from therapy. Fields may be provided here, for example, for allowing users to enter a professional written or legal electronic signature, the date, a physician's signature (if applicable), and the like.

Thus far, the disclosed embodiments have been described with respect to new clients; however, those having ordinary skill in the art will understand that the disclosed embodiments are fully applicable to existing clients as well. These existing clients are clients who are already enrolled in therapy, but for whom a file needs to be created in the system. Existing clients may be logged into the system by creating an evaluation report. Users may do this by following the same procedures as for entering a new client. The new client option from the File menu mentioned previously allows users to select the type of report they want to create. Users may select from the available options including adult, child, infant or dysphagia reports.

In some embodiments, a report tracking summary may be provided as an administrative tool to track client data generation activities from the beginning to the conclusion of the therapy process. Such a tracking summary may be initiated, for example, after generation of an evaluation report (see FIG. 3) and may then be used to chronicle all reports, notes and data transmissions, identify note and visit status, count visit number and number of visits remaining in an authorized service period, and the like.

FIG. 24 illustrates an example of a tracking summary 2400 according to the disclosed embodiments. The exemplary tracking summary 2400 may include a field for the client name, which may be automatically populated upon selection of a client using data from the evaluation report for that client. Columns may be provided in the tracking summary 2400 for displaying various reports, notes, data transmissions, visit status, visit count, and the like. Examples of columns may include the following:

Report Type: lists each document generated (e.g., evaluation report, progress report, progress note, etc.) and records any copies of the document.

Service Date: gives the date of the service corresponding to the listed document.

Completed: indicates finalized report date (this field may be automatically populated when the report is finalized, as described below).

Signed: indicates the date the therapist signed the report on completion (this field may populate simultaneously with the completed date when the report is finalized).

Copies: identifies the number of copies made.

To Insurance: indicates the date a report was sent to the insurance company.

To Family: indicates the date a report was sent to the client's family.

To Physician: indicates the date a report was sent to the referring physician.

Note Status: reflects daily billing activity, including any Super Bill, a billed note, cancellation and no-show.

Visit No.: counts the number of visits from the initial evaluation visit through the discharge visit (cancellations and no-shows may be listed, but do not affect the visit number count).

No. Left: indicates the number of visits remaining and reflects the client's authorization status (visits count downward from the total number of authorized visits to zero, reflecting the end of the authorized visit period).

Although not expressly shown, in some embodiments, opened notes and reports may appear as indexed tabs along the top edge of the tracking summary 2400. These opened documents may then be viewed by clicking on the desired indexed tab.

A finalized report means the report is completed and users do not want to make any more changes to the report contents. Reports may be finalized by selecting an appropriate menu option, for example, from the File menu. Finalizing a report makes it a permanent record by freezing the report contents. Each report, including evaluation, progress and discharge documents, should be finalized before creating a subsequent report. The date a report is finalized may automatically populate the ‘Completed’ and ‘Signed’ columns of the tracking summary, along with the number of copies made in the ‘Copies’ column. In some embodiments, when finalizing a report, a dialogue box may appear asking users to complete any missing information. Users may then fill in any blank entry fields in the report at that time.

In addition, government regulations may require accountability for all personal client data leaving the office setting. Accordingly, in some embodiments, finalizing a report creates a tracking event screen (not expressly shown) that allows users to indicate to whom the client record is being sent and the date on which date it was sent. Users should check the tracking event screen to make sure the designated client name matches that of the client report they are finalizing. In some embodiments, the tracking event screen may include a date signed blank and a date completed blank that show the date users finalized the report. Double-clicking on a date to insurance box and a date to family box of the tracking event screen adds the current day's date. Users may adjust the date by typing the desired date in the correct blank. The number of copies made may be designated in the number of copies space provided. Selecting a ‘Save’ option keeps the finalized version and adds it to the tracking summary 2400, while selecting a ‘Cancel’ option returns users to the selected report.

Copies of a report may be sent at any time, but governmental regulations may require accountability for all personal client data leaving the clinic setting. To this end, appropriate menu options may be provided to allow users to indicate that a copy of a report or a note has been sent (e.g., click ‘Report Sent’ or ‘Note Sent’). The copy information may then be used to automatically populate the tracking summary 2400, making the sent item a part of the client's permanent record.

To log a sent item, users may select an appropriate option from the File menu, (e.g., click ‘Add Report’). When this happens, in some embodiments, the tracking event screen appears in order to log which party a report, note or note range was sent and the date on which it was sent. Sent reports and notes automatically populate the tracking summary with the number of copies made, the date the copies were sent, and to whom the copies were sent.

In some embodiments, a dialogue box may appear after sending a report or note asking if users want to send any additional documents. A ‘Yes’ response allows users to select the desired document from the tracking summary, while a ‘No’ response returns the client's file to the tracking summary.

In some embodiments, a print function may be provided, for example, on the main toolbar to allow users to print a note, range of notes, reports and billing invoices. Users may then print a document by opening the document, clicking ‘Print’ from the file menu, scrolling down to the specific print function and clicking on it.

In some embodiments, where the speech therapy service provider has multiple locations, a branch menu function on the toolbar allows users to toggle from location to location. Users may then move from branch to branch by clicking the desired listed location.

In some embodiments, a new client menu option may be provided for listing available report types. The report type selection may depend upon the level of speech and language sophistication of the client. Examples may include: adult (for post-linguistic speech and language information), child (for developing speech and language descriptions), infant (for pre-linguistic speech development), dysphagia (for clients with swallowing disorders), and macro documents (for customized template documents).

In some embodiments, a find client menu option may be provided to allow users to search for clients in many different ways. Examples may include: specific (searches for a client by last name and first name), all (introduces a complete list of clients for a company or the designated company branch), alphabetic (allows users to select a letter category and then the specific letter corresponding to the client's last name), and today's (lists all the clients scheduled for the current calendar date).

In some embodiments, a calendar function may be provided to allow the user to search for clients by date, by date range, and by evaluator. Users may use arrow keys to select a desired month and then click on the date users wish to search for a client list. In some embodiments, an evaluator function may be provided to allow users to select a specific therapist's schedule and search for a specific date. In some embodiments, an unbilled notes function may be provided to show users all notes remaining unbilled. In some embodiments, an appointment without notes function may be provided to allow users to make an employment without creating a note. In some embodiments, unsigned notes may be created by an administrator to await assignment to an evaluator. In some embodiments, inactive client records may be located in the inactive file that is not subject to manipulation. In some embodiments, a clear function may be provided as a privacy measure to protect data from unauthorized scrutiny by transferring users to the cover page without altering the work in progress. In some embodiments, an evaluator-only function may be provided for offices with multiple evaluators (therapists). The evaluator-only function displays a list showing a complete client list.

In some embodiments, a billed hours function may show billing information generated from completed progress notes. Users may then view billing information by date designations, for example, today, yesterday, this week, last week, this month and last month. All billed hours documents may capture data in a similar manner and may be populated directly from notes where ‘Bill Now’ has been selected.

FIG. 25 illustrates an example of a billed hours summary 2500. As can be seen, the billed hours summary 2500 may include a list of the clients who have received service along with the date on which the service was provided. The summary 2500 may additionally list the insurance company for each client, the particular number of the visit (e.g., 6^{th}, 8^{th}, etc.), and the total number of billed service units. Typically, one service unit equals one hour of service, but other arrangements may certainly be used. Other information that may be included on the summary 2500 may be the treatment type (e.g., evaluation, diagnostic therapy, therapy, etc.), the CPT and/or IDC9 codes, the number of service units that are associated with each code, as well as the status of the bill (e.g., whether the bill has been billed). Continued, no-shows and cancellations may also be listed on the summary 2500, although no bill is associated with these entries. Such an arrangement provides users with a convenient overview of the cases that have accrued for a given day. Users may then choose any of the entries on the summary 2500 to view or print the bill associated therewith.

Although not expressly shown, other operations that may be provided according to the disclosed embodiments include various administrative operations. These operations may include, for example, removal of notes and reports, client file transfers, changing client status (e.g., deactivate, reinstate, etc.), viewing client ID information, appointment scheduling options, visit authorizations, date authorizations, changing client branches, changing client therapist, changing user passwords and the like. Numerous ways known to those having ordinary skill in the art may be used for implementing these operations and, therefore, a specific discussion thereof is omitted here for economy of the description.

In some embodiments, the clinical progress tracking and caseload management application described above may be implemented using a database. Client data, speech services data, assessment data, treatment plan data, and recommendations data may then be exported and imported between systems of the same or different types as needed in a manner known to those having ordinary skill in the art. Table 4 below illustrates an exemplary implementation of the application using an SQL database, where operations that may be performed are listed in uppercase text and input tables, input data, and output tables impacted by each operation are listed immediately below the operation. Of course, those having ordinary skill in the art will understand that other database implementations of the disclosed embodiments may be derived without departing from the disclosed embodiments. Note in Table 4 that multiple input tables may share the same input data.

TABLE 4
NEW CLIENT

| Input Tables | Company | Branch | Staff | CPT | ICD-9 | Functions | Tests Administered | Goals |
|---|---|---|---|---|---|---|---|---|
| Input Data | Client | Services | Assessment | Tx Plan | Recommendation | | | |
| Output Tables | Tracking | Client | Report | | | | | |

FINALIZE REPORT

| Input Tables | Report | Client | No. of copies distributed |
|---|---|---|---|
| Output Tables | Tracking | | |

NEW PROGRESS REPORT

| | | | | | | | | | | |
|---|---|---|---|---|---|---|---|---|---|---|
| Input Tables | Report | Company | Branch | Staff | Client | CPT | ICD-9 | Functions | Tests | Goals |
| | | | | | | | | | Administered | |
| Input Data | Client | Services | Assessment | Tx Plan | Recommendation | | | | | |
| Output Tables | Tracking | Client | Report | | | | | | | |

NEW DISCHARGE REPORT

| | | | | | |
|---|---|---|---|---|---|
| Input Tables | Report | Company | Branch | Staff | Client |
| Input Data | Client | Services | Assessment | Dc Plan | Recommendation |
| Output Tables | Tracking | Client | Report | | |

AUTHORIZE VISITS

| | | |
|---|---|---|
| Input Tables | Client | |
| Input Data | Visit Nos. | Visits Dates |
| Output Tables | Client | |

SCHEDULE VISITS

| | | | | | |
|---|---|---|---|---|---|
| Input Tables | Client | Schedule | Staff | Branch | Company |
| Input Data | Visit Date | Visit Time | Visit Units | | |
| Output Tables | Schedule | | | | |

NEW NOTE

| | | | | | | | | | | |
|---|---|---|---|---|---|---|---|---|---|---|
| Input Tables | Schedule | Staff | Branch | Client | Reports | Tracking | Staff | Company | CPT | ICD-9 |
| Input Data | (S) | (O) | (A) | (P) | | | | | | |
| Output Tables | Notes | Schedule | Tracking | Client | | | | | | |

BILLING REPORT

| | | | | | |
|---|---|---|---|---|---|
| Input Tables | Notes | Clients | Staff | Branch | Company |
| Input Data | Dates | Branches | Company | | |

| | |
|---|---|
| Output | Spreadsheet with billing information |

FIND CLIENT

| | | | | | | |
|---|---|---|---|---|---|---|
| Input Tables | Schedule | Staff | Branch | Company | Notes | Client |

| | |
|---|---|
| Input Data | Search criteria |

| | |
|---|---|
| Output | List of clients matching criteria |

DISPLAY/PRINT REPORT

| | | | | |
|---|---|---|---|---|
| Input Tables | Report | Staff | Branch | Company |

| | |
|---|---|
| Input Data | Select from items on tracking table |
| Output | Text version of report |

DISPLAY/PRINT NOTE

| | | | |
|---|---|---|---|
| Input Tables | | | |
| Notes | Staff | Branch | Company |

| | |
|---|---|
| Input Data | Select from dialog box using visit numbers or visit dates |
| Output | Text version of note(s) |

CHANGE BRANCH

| | | | |
|---|---|---|---|
| Input Tables | Branches | Staff | Company |

| | |
|---|---|
| Input Data | Select from menu displaying all branches authorized to use |
| Output | Change of branch to view that branch's clients |

CHANGE CLIENT BRANCH

| | | | | | | | | |
|---|---|---|---|---|---|---|---|---|
| Input Tables | Company | Branch | Staff | Client | Tracking | Reports | Schedule | Notes |
| Input Data | Client ID | | | | | | | |
| Output Tables | Client | Tracking | Reports | Schedule | Notes | | | |

CHANGE CLIENT EVALUATOR

| | | | | | |
|---|---|---|---|---|---|
| Input Tables | Company | Branch | Staff | Client | Schedule |
| Input Data | Client ID | Staff ID | | | |
| Output Tables | Client | Schedule | | | |

CHANGE CLIENT STATUS

| | | |
|---|---|---|
| Input Tables | Client | |
| Input Data | Client ID | Status |
| Output Tables | Client | |

CHANGE EVALUATOR WORK WEEK

| | |
|---|---|
| Input Tables | Company |

| | |
|---|---|
| Input Data | Work any day/work days specified in Company table |
| Output | Schedule allows appointments for given days |

ALLOW OVERLAPPING SCHEDULES

| | |
|---|---|
| Input Tables | Company |

| | |
|---|---|
| Input Data | Schedule multiple appointments for the same time period |
| Output | schedule allows appointments for any time of day |

In the implementation represented by Table 4, client data is separated by company, branch, and staff tables. Clients may be moved among staff members and branches, but not company. The tracking table connects all of a client's data together and contains references to a client's reports and notes. The client table contains data that can be used to keep track of insurance information. Client data is updated every time a report or note is completed. Report data is comprised of at least one evaluation report and may have one or more progress reports and a discharge report. A note is completed after each therapy session and is associated with the last report in a report table. The tracking table keeps a pointer to each report and note as well as sub-records noting when reports are sent to insurance companies and guardians of clients or clients themselves. The tracking table contains an index of company, branch, staff, client, report number, and note number.

When a report is built, the note number is assigned a large, constant number. When a note is build, the note number is sequentially incremented from one and the report number is the number of the last report. In addition, the tracking table keeps a running total of note numbers so that the schedule table can point to a particular note number. The schedule keeps track of client appointments. As new notes are added that must associate with an entry in the schedule table. The time-of-day and length-of-treatment tables are indexes so that the report, note, tracking, and schedule tables don't keep actual times and lengths of appointments in hours and minutes.

Furthermore, when a new client is first entered into the system, the client table gets a new entry. When the first evaluation report is entered, the client table is updated, and new records are made in the report and tracking tables. Thereafter, when new evaluation, progress or discharge reports are created, new records are made in the report file and the tracking file, and the client file is updated. When a note is created, a new record is made in the schedule, the tracking, and the report table, and an update in the client table is made. Entries in the schedule table can be made without a note, and the note is later attached upon building a new note. Any tables in Table 4 not specifically discussed may contain data of a type indicated by the names of the tables.

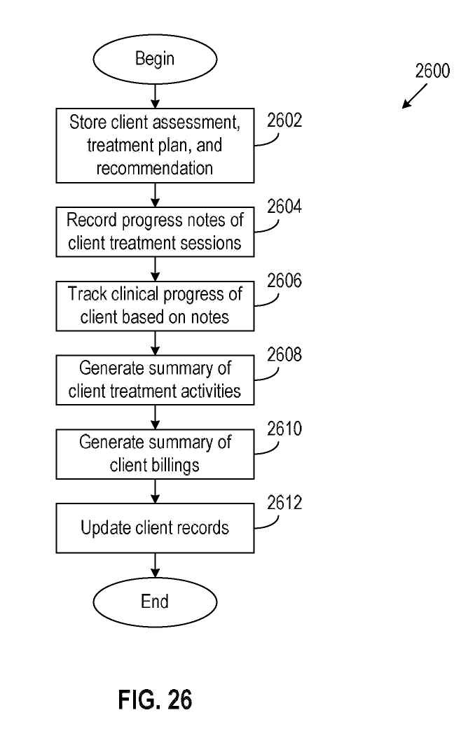

Thus far, specific embodiments have been disclosed for providing speech therapy clinical progress tracking and caseload management according to the disclosed embodiments. Referring now to FIG. 26, general guidelines are shown in the form of a method 2600 for providing speech therapy clinical progress tracking and caseload management that may be used to implement the various embodiments disclosed above. Those having ordinary skill in the art will understand, of course, that the method 2600 represents one exemplary embodiment only, and that other methods may certainly be derived without departing from the scope of the disclosed embodiments.

As can be seen in FIG. 26, the method 2600 begins at block 2602, where client assessment, treatment plan, and recommendation information may be stored, for example, in a file of the client. At block 2604, notes of client treatment sessions may be recorded, including, for example, activities performed, test given, progress made, and the like. At block 2606, clinical progress of the client may be tracked based at least on the notes and may include, for example, any changes in the severity of the client's condition. In some embodiments, the clinical progress may be tracked in a manner such that the progress is quantifiable, for example, by using numerical measures of progress. From time to time, as indicated at block 2608, reports may be generated summarizing the client's treatment activities, including dates when various reports and notes where started and completed, which interested parties received copies or the reports and when, billing status, and the like. At block 2610, a summary of all client billings may be generated, for example, for a given day, location, and the like. Users may then select and print bills for a particular client from the summary. At block 2612, updates may be made to client records to reflect any modified information, such as a change in condition or severity, new insurance information, and the like.

While the disclosed embodiments have been described with reference to one or more particular implementations, those skilled in the art will recognize that many changes may be made thereto. Therefore, each of the foregoing embodiments and obvious variations thereof is contemplated as falling within the spirit and scope of the disclosed embodiments, which are further set forth in the following claims.

1. A computerized system for managing therapy services provided to clients, the system comprising:
at least one subsystem configured to store assessment information, treatment plan information, and recommendation information for a client;
at least one subsystem configured to record progress notes of treatment sessions for the client, each progress note including treatment information pertaining to one treatment session; and
at least one subsystem configured to track an amount of clinical progress for the client over multiple treatment sessions, wherein the amount of clinical progress for the client is automatically derived based at least on the progress notes for the client.

2. The system of claim 1, wherein the amount of clinical progress for the client is numerically quantifiable.

3. The system of claim 1, wherein the amount of clinical progress for the client is tracked on a function by function basis.

4. The system of claim 1, wherein the therapy services include one of:
speech therapy services, occupational therapy services, physical therapy services, psycho therapy services, and chemotherapy services.

5. The system of claim 1, further comprising at least one subsystem configured to generate a report for the client, the report including one of: an evaluation report, a progress report, and a discharge report.

6. The system of claim 5, wherein the reports contain substantially the same data sections.

7. The system of claim 6, wherein the data sections comprise a client data section, a services data section, an assessment data section, a treatment plan data section, and a recommendations data section.

8. The system of claim 1, further comprising at least one subsystem configured to generate a tracking summary for the client, the tracking summary including information pertaining to reports generated for the client, dates the reports were started and completed, copies of the reports sent to interested parties, billing status of the client.

9. The system of claim 1, further comprising at least one subsystem configured to generate a billing summary for the clients, wherein the billing summary is automatically derived based at least on the progress notes for each client.

10. The system of claim 9, wherein the billing summary includes information pertaining to session date, treatment type, treatment date, insurance company, insurance code, and billing status for each client.

11. A computerized method of managing therapy services provided to clients, the method comprising:
storing assessment information, treatment plan information, and recommendation information for a client;
recording progress notes of treatment sessions for the client, each progress note including treatment information pertaining to one treatment session; and
tracking an amount of clinical progress for the client over multiple treatment sessions, wherein the amount of clinical progress for the client is automatically derived based at least on the progress notes for the client.

12. The method of claim 11, wherein the amount of clinical progress for the client is numerically quantifiable.

13. The method of claim 11, wherein the amount of clinical progress for the client is tracked on a function by function basis.

14. The method of claim 11, wherein the therapy services include one of: speech therapy services, occupational therapy services, physical therapy services, psycho therapy services, and chemotherapy services.

15. The method of claim 11, further comprising generating a report for the client, the report including one of: an evaluation report, a progress report, and a discharge report.

16. The method of claim 15, wherein the reports contain substantially the same data sections.

17. The method of claim 16, wherein the data sections comprise a client data section, a services data section, an assessment data section, a treatment plan data section, and a recommendations data section.

18. The method of claim 11, further comprising generating a tracking summary for the client, the tracking summary including information pertaining to reports generated for the client, dates the reports were started and completed, copies of the reports sent to interested parties, billing status of the client.

19. The method of claim 11, further comprising generating a billing summary for the clients, wherein the billing summary is automatically derived based at least on the progress notes for each client.

20. The method of claim 19, wherein the billing summary includes information pertaining to session date, treatment type, treatment date, insurance company, insurance code, and billing status for each client.

21. A computer-readable medium encoded with computer-readable instructions for managing therapy services provided to clients, the computer-readable instructions comprising instructions for causing a computer to:
store assessment information, treatment plan information, and recommendation information for a client;
record progress notes of treatment sessions for the client, each progress note including treatment information pertaining to one treatment session; and
track an amount of clinical progress for the client over multiple treatment sessions, wherein the amount of clinical progress for the client is automatically derived based at least on the progress notes for the client.

22. The computer-readable medium of claim 21, wherein the amount of clinical progress for the client is numerically quantifiable.

23. The computer-readable medium of claim 21, wherein the amount of clinical progress for the client is tracked on a function by function basis.

24. The computer-readable medium of claim 21, wherein the therapy services include one of: speech therapy services, occupational therapy services, physical therapy services, psycho therapy services, and chemotherapy services.

25. The computer-readable medium of claim 21, further comprising instructions for causing a computer to generate a report for the client, the report including one of: an evaluation report, a progress report, and a discharge report.

26. The computer-readable medium of claim 25, wherein the reports contain substantially the same data sections.

27. The computer-readable medium of claim 26, wherein the data sections comprise a client data section, a services data section, an assessment data section, a treatment plan data section, and a recommendations data section.

28. The computer-readable medium of claim 21, further comprising instructions for causing a computer to generate a tracking summary for the client, the tracking summary including information pertaining to reports generated for the client, dates the reports were started and completed, copies of the reports sent to interested parties, billing status of the client.

29. The computer-readable medium of claim 21, further comprising instructions for causing a computer to generate a billing summary for the clients, wherein the billing summary is automatically derived based at least on the progress notes for each client.

30. The computer-readable medium of claim 21, wherein the billing summary includes information pertaining to session date, treatment type, treatment date, insurance company, insurance code, and billing status for each client.
